(19) United States
(12) Patent Application Publication
(10) Pub. No.: US 2024/0259814 A1
(43) Pub. Date: Aug. 1, 2024

(54) METHOD AND APPARATUS FOR CLOUD-BASED PERIPHERAL DEVICE ASSIGNMENT FOR PAIRING

(71) Applicant: Dell Products, LP, Round Rock, TX (US)

(72) Inventors: Anantha K. Boyapalle, Cedar Park, TX (US); Kai Leong Wong, Singapore (SG); Nicholas D. Grobelny, Evergreen, CO (US)

(73) Assignee: Dell Products, LP, Round Rock, TX (US)

(21) Appl. No.: 18/104,067

(22) Filed: Jan. 31, 2023

(51) Int. Cl. H04W 12/50; H04W 12/037; H04W 76/14

(52) U.S. Cl. CPC H04W 12/50; H04W 12/037; H04W 76/14

(57) ABSTRACT

An information handling system includes a hardware processor and a memory device, the processor executing code instructions of an automatic peripheral device (PD) pairing management system pairing agent to receive and store a temporary key and peripheral device identification data (PD ID) associated with a peripheral device assigned to the information handling system from a backend management server via secure wireless link. In response to a pairing query from the assigned peripheral device including a sent PD ID, the automatic PD pairing management system pairing agent determines that the received PD ID matches the stored PD ID and verifies BT pairing with the peripheral device is authorized by determining that the temporary key received from the backend management server matches a peripheral device temporary key stored at the peripheral device before establishing a Bluetooth® wireless link between the peripheral device and the information handling system.

### FIELD OF THE DISCLOSURE

The present disclosure generally relates to Bluetooth® pairing of a peripheral device with an information handling system. The present disclosure more specifically relates to automatic pairing of a Bluetooth® device with an information handling system coupled to a backend management server.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. Still further, information handling systems may be operatively coupled to, via a pairing process, various peripheral devices that allow a user to interact with the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a backend coupled information handling system including an automatic peripheral device pairing management system with a pairing agent operatively coupled to a backend management server according to an embodiment of the present disclosure;

FIG. 2 is a graphic diagram of an information handling system with an automatic peripheral device pairing management system agent and one or more wireless peripheral devices according to an embodiment of the present disclosure;

FIG. 3 is a process flow diagram of a method of automatically Bluetooth® pairing a peripheral device to a backend coupled information handling system according to an embodiment of the present disclosure; and

FIG. 4 is a process flow diagram of a method of assigning a peripheral device with an information handling system and automatically Bluetooth® pairing that peripheral device to the backend coupled information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Information handling systems operate to provide computing, data storage, and application resources among other computing resources. A plurality of peripheral devices (PDs) may be operatively coupled, wirelessly, to the information handling system such as via a Bluetooth® (BT) wireless protocol, including Bluetooth Low-Energy (BLE) protocols. The PDs allow the user to interact with the information handling system by receiving output and proving input to the information handling system. Some PDs may serve as both input and output devices. Although some PDs may have a wired connection with the information handling system, wireless PDs are operatively coupled to the information handling system via a radio of a wireless interface adapter in the information handling system and a radio located within the PDs, for example BT wireless systems. In order to allow for the operative coupling of a PD to the information handling system, the wireless PD may initiate a pairing process. This pairing process, in order for the operative coupling to be secure, includes security protocols that securely couple the PD to the information handling system. This prevents the PD from being operatively coupled to information handling systems that are not associated with the user. In some instances, this requires the user to input certain pairing credentials such as a unique number in order to pair the PD with the information handling system. Along with this pairing process requiring user input to initiate the pairing process (e.g., not being automatic), it was not entirely secure and could result in a third-party gaining control of the PD using another information handling system with leak of a pairing code or intercept of the pairing exchange.

The present specification describes an information handling system that includes a hardware processor, a memory device, and a power management unit (PMU) to provide power to the processor and memory device. The information handling system further includes computer readable program code of an automatic PD pairing management system pairing agent to, when executed by the hardware processor, receive temporary key and device identification data associated with a plurality of peripheral devices from a backend management server executing an automatic PD pairing management system. The backend management server, in an embodiment, executes code instructions of the automatic PD pairing management system to generate and establish the temporary key and device identification data to be associated with each of the plurality of peripheral devices based on a pairing assignment of each of the plurality of peripheral devices with one of a plurality of backend coupled information handling systems. In an embodiment, the plurality of backend coupled information handling systems may be grouped within an enterprise. The assignment of the PD to any backend coupled information handling system may be done by an information technology decision maker (ITDM) of an enterprise or by a single user at the backend management server or via a PD registration system for an enterprise. This generated temporary key is also stored on a memory of the PD by the wireless PD manufacturer for later pairing confirmation.

The computer readable program code of an automatic peripheral device pairing management system to, when executed by the hardware processor, also sends instructions to each of the plurality of backend coupled information handling systems to store the temporary key and device identification data associated with the peripheral device assigned to each of the backend coupled information handling systems. In an embodiment, the temporary key and device identification data stored as a unified extensible firmware interface (UEFI) variable in a UEFI memory device accessible by the hardware processor at the backend coupled information handling system.

The computer readable program code of an automatic peripheral device pairing management system to, when executed by the hardware processor, also sends instructions to each of the plurality of backend coupled information handling systems to, with a wireless adapter, establish an out-of-band (OOB) BT communication via an extended communication channel in an OOB BT broadcast communication channel with one of the plurality of peripheral devices in an embodiment. In an embodiment, the OOB BT communication in an OOB BT broadcast communication channel is used via execution of code instructions of the automatic PD pairing management system pairing agent to query, verify and initiate pairing the one of the plurality of peripheral devices with the backend coupled information handling system using the temporary key and device identification data assigned to the backend coupled information handling system. Upon verification of pairing to the wireless PD with the peripheral device identification (PD ID) and temporary key (TK) and device identification data, initiation and configuration of a secure BT wireless link may be established with a session key under normal BT protocols. This system and method allows for, in an example embodiment, an ITDM or other technology manager of an enterprise to order a plurality of PDs for any number of users. These PDs may be specifically assigned to each user's specific information handling system or may be available to be operatively coupled to any of a plurality of backend coupled information handling systems such as within a specified working group of an enterprise. The automatic query and verification followed by initiation and configuration of the BT pairing process executed by the automatic peripheral device pairing management system and its pairing agent at a backend coupled information handling system of embodiments described herein allows for either the specific assignment of any given PD to a specific backend coupled information handling system or for one or more PDs to be assigned to any of a group of backend coupled information handling systems via a backend management server.

In an embodiment, the instructions to each of the plurality of backend coupled information handling systems includes data describing wireless peripheral device verification requirements that require the temporary key and device identification data to match a peripheral device temporary key and device identification data stored on the PD and provided by the peripheral device. Instead of a user being required to provide input to pair the PD to the information handling system, the presently described system executed code instructions of an automatic peripheral device pairing management system and its pairing agent at a backend coupled information handling system avoids burdensome pairing procedures to be required by users.

The execution of the computer readable program code of the automatic peripheral device pairing management system at a backend management server and a pairing agent by the hardware processor such as the embedded controller at a backend coupled information handling system allows for a more secure method of automatically pairing a wireless PD to a backend coupled information handling system. By providing matching temporary key and device identification data to the backend coupled information handling system over a secure connection with a backend management server as well as saving a matching PD temporary key and PD ID on a memory device of the PD, the present embodiments allow the specific PD to be paired with only the specific backend coupled information handling system or an assigned group of backend coupled information handling systems as described herein.

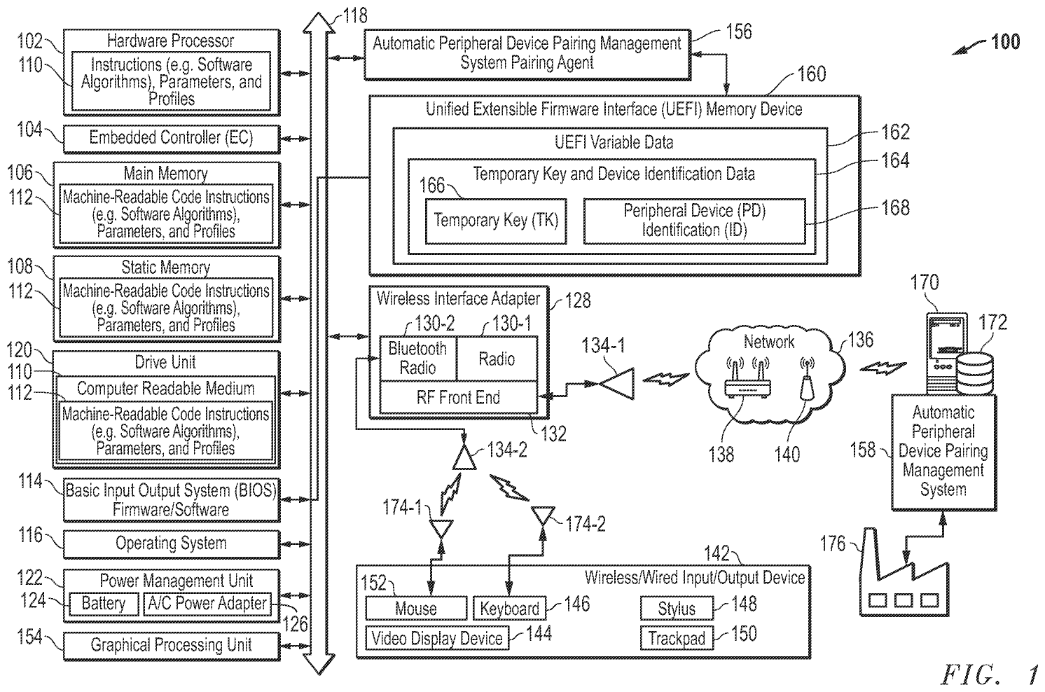

FIG. 1 illustrates a backend coupled information handling system 100, similar to information handling systems according to several aspects of the present disclosure, that executes code instructions of an automatic peripheral device pairing management system pairing agent 156 according to an embodiment. The backend coupled information handling system 100 executes, with a hardware processor 102, embedded controller 104, or other hardware processing resources, an automatic peripheral device pairing management system pairing agent 156 that may interface with a backend management server 170 executing code instructions of an automatic peripheral device pairing management system 158 in the embodiments described herein. In the embodiments described herein, a backend coupled information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an backend coupled information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a two-in-one computer, a tablet, a smartphone, a communications device, an access point (AP), a base station transceiver, a wireless telephone, a control system, a camera, a scanner, a printer, a personal trusted device, a web appliance, or any other suitable machine capable of executing a set of machine-readable code instructions (sequential or otherwise) that specify actions to be taken by that machine, and can vary in size, shape, performance, price, and functionality.

In a networked deployment, the backend coupled information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, a backend coupled information handling system 100 may be any mobile or other computing device capable of executing, via a hardware processing resource, a set of machine-readable code instructions (sequential or otherwise) that specify actions to be taken by that machine. In an embodiment, the backend coupled information handling system 100 may be operatively coupled to a server such as the backend management server 170 or other network device as well as with any wireless peripheral devices 142. Further, while a single backend coupled information handling system 100 is illustrated, the term “system” shall also be taken to include any collection of hardware systems or hardware sub-systems that individually or jointly utilize one or more hardware processing resources to execute a set, or multiple sets, of machine-readable code instructions to perform one or more computer functions.

The backend coupled information handling system 100 may include memory (volatile (e.g., random-access memory, etc.), nonvolatile (read-only memory, flash memory etc.) or any combination thereof), one or more hardware processing resources, such as a central processing unit (CPU) 102, a graphics processing unit (GPU) 154, an embedded controller (EC) 104, other hardware processing device, hardware controller, or any combination thereof. Additional components of the backend coupled information handling system 100 can include one or more storage devices, one or more communications ports for communicating with external devices, as well as various input and output (I/O) devices 142, such as a keyboard 146, a mouse 152, a video display device 144, a stylus 148, a trackpad 150, or any combination thereof. The backend coupled information handling system 100 can also include one or more buses 116 operable to transmit data communications between the various hardware components described herein. Portions of a backend coupled information handling system 100 may themselves be considered information handling systems and some or all of which may be wireless.

Backend coupled information handling system 100 can include devices or modules that embody one or more of the hardware devices or hardware processing resources to execute machine-readable code instructions for the one or more systems and modules described above and operates to perform one or more of the methods described herein. For example, machine-readable code instructions may be executed by an EC 104, the hardware processor 102, or other hardware processing resource of a backend management server 170 for an automatic peripheral device pairing management system 156 or execute instructions of an automatic peripheral device pairing management system pairing agent 156 at a backend coupled information handling system 100 to control the discovery, verification, and initialization of BT pairing of a peripheral device (PD) described in embodiments herein. The backend coupled information handling system 100 may include machine-readable code instructions, parameters, and profiles 112 executed via hardware processing resources that may operate on servers or systems, remote data centers, or on-box in individual client information handling systems according to various embodiments herein. In some embodiments, it is understood any or all portions of machine-readable code instructions, parameters, and profiles 112 may operate on a plurality of information handling systems 100.

The backend coupled information handling system 100 may include hardware processing resources such as a hardware processor 102, a central processing unit (CPU), accelerated processing unit (APU), a neural processing unit (NPU), a vision processing unit (VPU), the EC 104, a digital signal processor (DSP), a graphical processing unit (GPU) 154, a microcontroller, or any other type of hardware processing device that executes machine-readable code instructions to perform the processes described herein. Any of the hardware processing resources may operate to execute code that is either firmware or software code. Moreover, the backend coupled information handling system 100 can include memory such as main memory 104, static memory 108, and drive unit 120 (volatile (e.g., random-access memory, etc.), nonvolatile (read-only memory, flash memory etc.) or any combination thereof) that stores machine-readable code instructions, parameters, and profiles 112 including machine-readable code instructions, parameters, and profiles 112 of, in an example embodiment, an automatic peripheral device pairing management system pairing agent 156 or other computer executable program code as described herein. In embodiments described herein, computer-readable program code associated with the automatic peripheral device pairing management system pairing agent 156 may be stored on non-volatile memory such as main memory 104 and may be made to be accessible by a hardware processing device such as an EC 104 or the hardware processor 102 for execution. Similarly, an information handling system like 100 may operate, in whole or in part, as a backend management server 170 with hardware processing resources executing code instructions of an automatic peripheral device pairing management system 158 according to embodiments herein.

As shown, the backend coupled information handling system 100 may further include a video display device 144. The video display device 144, in an embodiment, may function as a liquid crystal display (LCD), an organic light emitting diode (OLED), a flat panel display, or a solid-state display. Although FIG. 1 shows a single video display device 144, the present specification contemplates that multiple video display devices 144 may be used with the information handling system to facilitate an extended desktop scenario, for example. In an embodiment, the video display device 144 may be used as an output device that allows the user to interact with the backend coupled information handling system 100. In one embodiment, the video display device 144 may be BT wirelessly coupled to the backend coupled information handling system 100 and may be paired with the backend coupled information handling system 100 via the methods described herein and via execution of the automatic peripheral device pairing management system pairing agent 156 by a hardware processing resource (e.g., EC 102, hardware processor 102).

Additionally, the backend coupled information handling system 100 may include one or more input/output devices 142, that may be wireless or wired, including an alpha numeric input device such as a keyboard 146 and/or a cursor control device, such as a mouse 152, touchpad/trackpad 150, a stylus 148, or a gesture or touch screen input device associated with the video display device 144 that allow a user to interact with the images, windows, and applications presented to the user. In an embodiment, the video display device 144 may provide output to a user that includes, for example, one or more windows describing one or more instances of applications being executed by the hardware processor 102 of the information handling system. In this example embodiment, a window may be presented to the user that provides a graphical user interface (GUI) representing the execution of that application. In an embodiment, a GUI may be presented to a user that allows a user to select from a plurality of backend coupled information handling systems to be assigned new wireless peripheral devices 142 with execution of the automatic peripheral device pairing management system 158 at the backend management server 170 as described herein. The present disclosure contemplates that any of these input/output devices 142 may be a wireless peripheral device (PD) ordered by and used by the user with the backend coupled information handling system 100. For example, a user may order a new wireless mouse 152 to be shipped to the user's location and used with the backend coupled information handling system 100 as a wireless input/output device 142. The methods and systems described herein allow for a streamlined and discovery, verification, and initialization of BT automatic pairing of the new PD (e.g., wireless mouse 152) to the backend coupled information handling system 100 in a secure manner.

The backend coupled information handling system 100 may further include a network interface device. The network interface device of the backend coupled information handling system 100 shown as wireless interface adapter 128 can provide connectivity among devices (e.g., wireless PDs 142 such as the input/output devices 142) such as with Bluetooth® (BT) or to a network 136, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 138 or base station 140 used to operatively couple the backend coupled information handling system 100 to a network 136. In a specific embodiment, the network 136 may include macro-cellular connections via one or more base stations 138 or a wireless access point 138 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the backend coupled information handling system 100. Wireless interface adapter 128 may include one or more radio frequency (RF) subsystems (e.g., radio 130-1, 130-2) with transmitter/receiver circuitry, modem circuitry, one or more antenna front end circuits 130, one or more wireless controller circuits, amplifiers, antennas 132 and other circuitry of the radio 130-1. 130-2 such as one or more antenna ports used for wireless communications via multiple radio access technologies (RATs). The radio 130-1, 130-2 may communicate with one or more wireless technology protocols. In one embodiment, the radio 130-1 operating as a WWAN module may contain individual subscriber identity module (SIM) profiles for each technology service provider and their available protocols for any operating subscriber-based radio access technologies such as cellular LTE communications. It is appreciated that the radios 130-1, 130-2 may be any type of wireless module operatively coupled to the RF front end 132 via, for example, I2C lines. These modules forming the radios 130-1, 130-2 include a WWAN module (e.g., radio 130-1), a WLAN module, a Bluetooth module (e.g., 130-2) or any other wireless protocol module used to operatively couple the backend coupled information handling system 100 to a network or to the wireless PDs 142 as described herein.

In an example embodiment, the wireless interface adapter 128, radio 130-1, 130-2, and antenna 134-1, 134-2 may provide connectivity to one or more of the wireless peripheral devices 142 that may include a wireless video display device 144, a wireless keyboard 146, a wireless mouse 152, a wireless headset, a microphone, a wireless stylus 148, and a wireless trackpad 150, among other wireless peripheral devices used as input/output (I/O) devices 142.

It is appreciated that these various radios 130-1, 130-2 may be each coupled to an antenna 134-1, 134-2 via the RF front end 132. In an embodiment, the wireless interface adapter 128 may include any number of antennas 134-1, 134-2 which may include any number of tunable antennas for use with the system and methods disclosed herein. Although FIG. 1 shows two antennas 134-1, 134-2, the present specification contemplates that the number of antennas 132 may include more or less of the number of individual antennas shown in FIG. 1. Additional antenna system modification circuitry (not shown) may also be included with the wireless interface adapter 128 to implement coexistence control measures via an antenna controller in various embodiments of the present disclosure.

In some aspects of the present disclosure, the wireless interface adapter 128 may operate two or more wireless links. In an embodiment, the wireless interface adapter 128 may operate a Bluetooth® wireless link (e.g., via Bluetooth radio 130-2 and antenna 134-2) using a Bluetooth® wireless or Bluetooth® Low Energy (BLE). In an embodiment, the Bluetooth® wireless protocol may operate at frequencies between 2.402 to 2.48 GHz.

The wireless interface adapter 128 may operate in accordance with any wireless data communication standards. To communicate with a wireless local area network, for example, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums.

The wireless interface adapter 128 can represent an add-in card, wireless network interface module that is integrated with a main board of the backend coupled information handling system 100 or integrated with another wireless network interface capability, or any combination thereof. In an embodiment the wireless interface adapter 128 may include one or more radio frequency subsystems including transmitters and wireless controllers for connecting via a multitude of wireless links. In an example embodiment, a backend coupled information handling system 100 may have an antenna system transmitter for Bluetooth®, BLE, 5G small cell WWAN, or Wi-Fi WLAN connectivity and one or more additional antenna system transmitters for macro-cellular communication. The RF subsystems and radios 128 and include wireless controllers to manage authentication, connectivity, communications, power levels for transmission, buffering, error correction, baseband processing, and other functions of the wireless interface adapter 128.

As described herein, the backend coupled information handling system 100 may include and be operatively coupled to an automatic peripheral device pairing management system pairing agent 156 that, when executed by a hardware processor 102, an EC 104, or other hardware processing resource, automatically manages a pairing query, verification, and initiation of BT pairing to pair a wireless PD 142 to the backend coupled information handling system 100 as described herein. The method of automatic query response, verification, and initiation of BT pairing includes receiving temporary key and device identification data 164 from a backend management server 170 by an automatic peripheral device pairing management system 158 to the backend coupled information handling system 100. The automatic peripheral device pairing management system 158 may be computer readable program code that, when executed by a hardware processing resource of the backend management server 170, communicates with, provides data to (e.g., temporary key and device identification data 164) one or more backend coupled information handling systems 100, and also manages one or more backend coupled information handling systems 100 as described herein. This temporary key and device identification data 164 may match peripheral device temporary key and device identification data 164 placed on a storage device of the peripheral device to be paired with the backend coupled information handling system 100 when code instructions of the automatic peripheral device pairing management system pairing agent 156 are executed. These symmetric temporary keys 166 and PD IDs 168 stored by the backend coupled information handling system 100 and stored on the wireless peripheral device 142 allow for the automatic query response, verification, and initiation of BT pairing process described herein to be completed. In an embodiment, the backend coupled information handling system 100 is communicatively coupled to a backend management server 170 that hosts a backend management server database 172 used to store temporary keys 166 and peripheral device (PD) identifications (IDs) 168 associated with one or more wireless peripheral devices 142 as described herein.

In an embodiment, the temporary keys 166 and PD IDs 168 stored on the backend management server database 172 are assigned to specific wireless PDs 142 upon purchase of the same. In another embodiment, the temporary keys 166 and PD IDs 168 stored on the backend management server database 172 are assigned to one of many possible information handling systems either associated with a specific user or specific group of users. Each of the temporary keys 166 may correlate with a specific PD ID 168 for a particular wireless PD 142 on the backend management server database 172. In an embodiment, the backend management server 170 is presented with the PD IDs 168 from a manufacturer 176 of the wireless PDs 142 or a third-party website that sells the wireless PDs 142, among other potential sources. Along with the PD IDs 168 the manufacturer 176 or third party may also provide data descriptive of the purchaser of the wireless PD 142. The manufacturer 176 or third party provides these PD IDs 168 to the backend management server 170 so that the backend management server 170 may cross-reference the purchaser, via the data descriptive of the purchaser of the wireless PD 142, with a backend coupled information handling system 100 or a plurality of backend coupled information handling systems used by the purchaser of the wireless PD 142. By correlating the purchase of the wireless PD 142 by purchaser with the purchaser's backend coupled information handling system, the backend management server 170 can store this data for later distribution to the corresponding information handling system.

By way of example, a manufacturer 176 of wireless PDs 142 may manufacture a wireless mouse 152. The manufacturer 176 may assign a PD ID 168 to the wireless PD 142 (e.g., a serial number) and store the PD ID 168 on a memory device located on the wireless mouse 152. In one embodiment, the manufacturer 176 may also generate a temporary key 166 used later in the method to query, verify, and pair the wireless mouse 152 with an information handling system (e.g., the purchaser's/user's backend coupled information handling system 100). In another embodiment, the backend management server 170 may be used to generate the temporary key 166 used later to query, verify, and BT pair the wireless mouse 152 with the backend coupled information handling system 100. In an embodiment, the temporary key 166 generated by the manufacturer 176 or the backend management server 170 is also stored on a memory device located on the wireless mouse 152. The memory device on the wireless mouse 152 may be any type of non-volatile memory that stores the PD ID 168 and temporary key 166 until the wireless PD 142 is turned on by the purchaser/user and a pairing process is started. It is appreciated that the purchaser of the wireless PD 142 in some embodiments herein may be the end user and the wireless mouse 152 may be any wireless PD 142. It is further appreciated that the purchaser of the wireless PD 142 may be a third party purchasing the wireless PD 142 on behalf of a user.

In another embodiment, the manufacturer 176 may cause the PD ID 168 to be stored on the memory device within the wireless mouse 152 and transmit data to the backend management server 170 without a generated temporary key 166 (e.g., the temporary key 166 to be generated at the backend management server 170). In an embodiment, further data accompanying the copy of the PD ID 168 may include data describing the purchaser/user. The data describing the purchaser/user may include a street address, purchase date, a purchaser identification, and other information that allows the backend management server 170 to determine if and which backend coupled information handling system 100 listed within the backend management server database 172 is owned by the purchaser/user of the PD. When the backend management server 170 receives the PD ID 168 associated with the recently purchased PD, hardware processing resources on the backend management server 170 may identify the user, determine whether a backend coupled information handling system 100 is associated with the user based on the data describing the purchaser/user, and store the correlated PD ID 168 with the purchaser/user in the backend management server database 172. In an embodiment where the temporary key 166 has not been generated by the manufacturer 176 of the PD, the backend management server 170, using a hardware processor, may create a temporary key 166 to also be stored with specific PD ID 168 and purchaser/user information. It is understood that temporary key 166 may be a type of cryptographic key used with embodiments herein such as a confirm value generation function as described below. Creation of the temporary key 166 may be accomplished, in an embodiment, by executing a random number generator, a hash function, a cryptographic hash function, or any other cryptographic key generating algorithm that creates a unique temporary key 166 using unique seed data to be associated with the wireless PD 142 and its PD ID 168. The execution of the random number generator, the hash function, the cryptographic hash function, or other cryptographic key generating algorithms may be done by a hardware processor of the backend management server 170 in an embodiment.

It is appreciated that the purchaser may be a purchaser of multiple wireless PDs 142 to be used on a plurality of backend coupled information handling systems 100. This includes information technology decision makers (ITDM) or other IT professionals within an organization or enterprise that have been assigned to purchase bulk or specific wireless PDs 142 for those backend coupled information handling systems 100 the ITDM is responsible to manage. The ITDM may order a plurality of wireless PDs 142 to be assigned to one of a plurality of information handling systems operated by specific users within, for example, an enterprise. In this embodiment, the PD ID 168 data may include a plurality of sets of PD IDs 168 so that any given wireless PD 142 may be paired with any of the plurality of backend coupled information handling systems when a user within the enterprise turns the wireless PD 142 on and a BT pairing process is initiated. In this example, correlated temporary keys 166 may be matched up with PD IDs 168 to verify that, regardless of the user or backend coupled information handling system, one of the ordered wireless PDs 142 may initiate BT pairing with one of the information handling systems.

When the PD ID 168 and correlated temporary key 166 and user information has been stored on the backend management server database 172, the backend management server 170 may provide this data to one or more information handling systems 100 the wireless PDs 142 are to be paired with. For example, where a single user has ordered a PD, the backend management server 170 may fulfill a request for the PD ID 168 and temporary key 166 data associated with their backend coupled information handling system 100 to be sent to the backend coupled information handling system 100. In another example where multiple wireless PDs 142 have been ordered, one or more PD IDs 168 and correlated temporary keys 166 may be sent to each of a plurality of the backend coupled information handling systems 100 in a group or to a specific backend coupled information handling systems 100.

In an embodiment, an ITDM may be provided with access to the backend management server 170 to assign specific wireless PDs 142 out of a plurality of ordered wireless PDs 142 to specific users and their respective information handling systems 100. In this embodiment, the specific PD ID 168 and temporary key 166 associated with a specific wireless PD 142 is provided to a specific user and backend coupled information handling system 100 pursuant to the ITDMs assignments of PDs. This assures that only a specific wireless PD 142 may be verified to initiate BT pairing with a specific backend coupled information handling system 100, even when multiple wireless PDs 142 are turned on at or near any specific backend coupled information handling system 100.

In an embodiment, the individual backend coupled information handling systems 100 may request any potential PD ID 168 and temporary key 166 periodically. For example, a software agent (e.g., Dell® SupportAssist®) of the backend coupled information handling system 100 with the automatic peripheral device pairing management system pairing agent 156 executed by a hardware processor may periodically send requests to the backend management server 170 for any potential PD ID 168 and temporary key 166 now assigned by the backend management server 170/ITDM to the user's backend coupled information handling system 100. In an embodiment, those backend coupled information handling systems 100 identified by the backend management server 170 as being associated with a specific user may be described as a backend coupled device that uses the software agent with the automatic peripheral device pairing management system pairing agent 156 to receive updates, software packages and the temporary key and device identification data 164 as described herein. Additionally, or alternatively, computer readable program code executed by a hardware processor on the backend management server 170 may detect that the backend coupled information handling system 100 is online and push the PD ID 168 and temporary key 166 to the backend coupled information handling system 100. As such the backend coupled information handling system 100 may be operatively coupled to the backend management server 170 via the network 136 using a wireless connection, a wired connection, or a combination of wired and wireless connections so that the PD ID 168 and temporary key 166 may be sent to and received at the backend coupled information handling system 100.

As each of the backend coupled information handling systems 100 (e.g., the backend coupled information handling system 100 shown in FIG. 1) receives the temporary key and device identification data 164 (e.g., temporary key 166 and PD ID 168) the PD ID 168 and temporary key 166 may be stored in unified extensible firmware interface (UEFI) memory device 160 as UEFI variable data 162 or stored in other memory devices in various embodiments. The UEFI memory device 160 may be any memory device that maintains the PD ID 168 and temporary key 166 for later retrieval by an operating system (OS) Bluetooth stack under direction of a hardware processor in one embodiment. In an embodiment, the UEFI variable data 162 is stored on a flash memory device associated with the basic input/output system (BIOS) 114. In an embodiment, the Bluetooth stack includes computer executable program code with hardware that, when executed by a hardware processor (e.g., hardware processor 102, embedded controller 104, or any other hardware processing resource) along with code instructions of the automatic peripheral device pairing management system pairing agent 156, performs automatic querying, verification, and initiation of BT pairing operations between the backend coupled information handling system 100 and wireless PD 142, and controls operations of a Bluetooth radio 130-2 under any BT protocols, among other functions. A plurality of protocols may be present in the Bluetooth stack which may include core protocols including Bluetooth radio, baseband, link manage protocol, logical link control and adaptation protocol, and service discovery protocols. The Bluetooth stack protocols may also include cable replacement protocols such as radio frequency communication protocols. Still further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 130-2) used to transmit radio waves at a specific frequency as described herein. The frequency with which the Bluetooth stack of the Bluetooth radio 130-2 queries the UEFI variable data 162 to determine if temporary key and device identification data 164 is available may vary. In an embodiment, the Bluetooth stack may query the UEFI memory device 160 for the UEFI variable data 162 during every power up of the backend coupled information handling system 100. In an embodiment, the Bluetooth stack may query the UEFI variable data 162 on the UEFI memory device 160 a plurality of times when the backend coupled information handling system 100 is powered up.

As the backend management server 170 receives the temporary key and device identification data 164 from the manufacturer 176 of the wireless PD 142, the manufacturer 176 of the wireless PD 142 may ship the wireless PD 142 to the user (e.g., ITDM or user of the backend coupled information handling system 100). The shipping of the wireless PD 142 to the end user may happen currently as the backend management server 170 correlates the PD ID 168 and a generated temporary key 166 with the user's identity and the backend coupled information handling system 100 operated by the user. Thus, in an embodiment, the temporary key and device identification data 164 may be relayed to the backend coupled information handling system 100 prior to the user receiving, via shipment, the PD. This allows the automatic peripheral device pairing management system pairing agent 156 to, with the Bluetooth stack, retrieve the temporary key 166 and PD ID 168 in preparation for automatic querying, verification, and initiation of BT pairing the wireless PD 142 (e.g., a wireless mouse 152) with the backend coupled information handling system 100.

As the user receives the wireless PD 142 from the manufacturer 176, the user may power up the wireless PD 142. In the example of the wireless mouse 152, this may include moving a power switch to an on position. The powering on of the wireless PD 142 causes the wireless PD 142 to broadcast signal via an out of band (OOB) BT broadcast wireless channel that indicates availability of the wireless PD 142 to pair and includes a pairing request. In the embodiments herein, this broadcast signal from the wireless PD 142 includes the PD ID 168 stored in the non-volatile memory device by the manufacturer 176 as described herein. The Bluetooth stack associated with the Bluetooth radio 130-2 may detect this PD ID 168 and, via execution of code instructions of the automatic peripheral device pairing management system pairing agent 156, compare it to the PD ID 168 received from the backend management server 170 by the backend coupled information handling system 100. Again, the PD ID 168 stored in the UEFI memory device 160 and accessed by the Bluetooth stack may include a plurality of PD IDs 168 when the ITDM has ordered a plurality of wireless PDs 142 for the user to use and simply passes the ordered wireless PD 142 to a random user of a backend coupled information handling system 100. Where the PD ID 168 provided by the wireless PD 142 device does not match the PD ID 168 accessed by the Bluetooth stack of the Bluetooth radio 130-2, the pairing process is not completed. Where the PD ID 168 provided by the wireless PD 142 matches the or one of the PD IDs 168 stored in the UEFI memory device 160, the automatic verification and initiation of BT pairing process may proceed via execution of code instructions of the automatic peripheral device pairing management system pairing agent 156. In an embodiment, the Bluetooth stack of the Bluetooth radio 130-2 may request certain received signal strength indicator (RSSI) data signal from the wireless PD 142. RSSI data is received by the BT radio 130-2 and the power level being received from the radio at the wireless PD 142 (e.g., after calculated antenna and cable loss) can be determined. RSSI threshold data received by the wireless interface adapter 128 indicates whether, in an embodiment, the wireless PD 142 is within a threshold range of the backend coupled information handling system 100. In an embodiment where multiple wireless PDs 142 had been ordered by a ITDM to be paired with any of a plurality of backend coupled information handling systems 100, the RSSI threshold may prevent other wireless PDs 142 that are not within a threshold distance of the user's backend coupled information handling system 100 from initiating automatic BT pairing. This may occur especially where two employees of an enterprise are to be given wireless PDs 142 to pair with their respective backend coupled information handling systems 100 and they are within close proximity to each other during the pairing process (e.g., cubicle neighbors, desk mates, etc.). The RSSI power level provided by the wireless PD 142 may be compared to a RSSI threshold value set at the Bluetooth radio 130-2. Where the detected wireless mouse 152 RSSI value does not meet or exceed the RSSI threshold value, the backend coupled information handling system 100 may ignore the pairing request of the PD. Where the RSSI value meets or exceeds the RSSI threshold value, the Bluetooth stack of the Bluetooth radio 130-2 may continue the automatic verification and initiation of BT pairing process to establish a BT wireless link.

The automatic verification and initiation of the BT pairing process, in an embodiment, is executed by code instructions of the automatic peripheral device pairing management system pairing agent 156 and includes the backend coupled information handling system 100 comparing the temporary key 166 to the copy PD temporary key stored at the wireless PD 142 attempting to BT pair. In an embodiment, the automatic verification and initiation of the BT pairing process may use a Bluetooth out-of-band (OOB), a legacy BLE OOB pairing, a Bluetooth Low Energy (BLE) OOB pairing protocol, or any other suitable protocol to verify and then to BT pair the wireless PD 142 to the backend coupled information handling system 100. In an embodiment, the backend coupled information handling system 100 and wireless PD 142 can each provide various automatic querying, verification, and BT pairing communications that includes the temporary key 166 verification and a pairing response command via an OOB BT communication. In an embodiment, the backend coupled information handling system 100 may calculate and encrypt an Mconfirm value from its copy of the temporary key 166 via a cipher algorithm such as a confirm value generation function, provide the encrypted Mconfirm to the wireless PD where it is decrypted there with the PD temporary key copy. Then the backend coupled information handling system receives an encrypted Sconfirm from the wireless PD 142 that calculated a PD Sconfirm value using its own stored copy of the PD temporary key and the confirm value generation function. A match of the received Sconfirm from the wireless PD 142 with the calculated Mconfirm in the backend coupled information handling system 100 may be used as verification that the temporary keys match. Where the values match, the BT pairing process establishes a session key and a BT wireless link via the OS BT stack and BT protocols. Then the BT pairing process is completed between the wireless PD 142 and backend coupled information handling system 100. In an embodiment, once the wireless PD 142 is paired with the backend coupled information handling system 100, the temporary key 166 is no longer used and may be deleted. In an embodiment, the temporary key 166 may be a single use temporary key in some embodiments with a copy from the wireless PD 142 by the manufacturer and a copy provided to the backend coupled information handling system 100.

The systems and methods described herein allows for a secure method of BT pairing a wireless PD 142 such as a wireless mouse 152. The method allows a backend coupled information handling system 100 to receive a temporary key 166 and PD ID 168 pair that is to be matched with a matching temporary key 166 and PD ID 168 stored on a wireless PD 142 delivered to a user and used when the wireless PD 142 initiates a pairing request. As such the temporary key 166 is secured and controlled by the backend management server 170 that has an existing relationship with a manage computing device such as the backend coupled information handling system 100 as well as access to peripheral device purchase information described herein.

The backend coupled information handling system 100 can include one or more sets of machine-readable code instructions, parameters, and profiles 112 that can be executed to cause the computer system to perform any one or more of the methods or computer-based functions disclosed herein. For example, machine-readable code instructions, parameters, and profiles 112 may execute; via hardware processing resources, various software applications, software agents, the BIOS 114 firmware and/or software, or other aspects or components. Machine-readable code instructions, parameters, and profiles 112 may execute, via the EC 104, the hardware processor 102, or any other hardware processing device, the automatic peripheral device pairing management system pairing agent 156 which controls the automatic querying, verification, and initiation of BT pairing of wireless PDs 142 with the backend coupled information handling systems 100 in embodiments herein. Again, the machine-readable code instructions, parameters, and profiles 112 of the automatic peripheral device pairing management system pairing agent 156 may be stored on a non-volatile memory device and made accessible to the EC 104, the hardware processor 104, or other hardware processing resource for execution. Various software modules comprising application instructions of machine-readable code instructions, parameters, and profiles 112 may be coordinated by an operating system (OS) 116, and/or via an application programming interface (API). An example OS 116 may include Windows®, Android®, and other OS types known in the art. Example APIs may include Win 32, Core Java API, or Android APIs.

The disk drive unit 120 and may include machine-readable code instructions, parameters, and profiles 112 in which one or more sets of machine-readable code instructions, parameters, and profiles 112 such as software can be embedded to be executed by the processor 102 or other hardware processing devices such as a GPU 154 to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 154 of backend coupled information handling system 100. The main memory 106, GPU 154, EC 104, and the hardware processor 102 also may include computer-readable media.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the backend coupled information handling system 100 may further include a power management unit (PMU) 122 (a.k.a. a power supply unit (PSU)). The PMU 122 may include a hardware controller and executable machine-readable code instructions to manage the power provided to the components of the backend coupled information handling system 100 such as the hardware processor 102, and other hardware components described herein. The PMU 122 may control power to one or more components including the one or more drive units 120, the hardware processor 102 (e.g., CPU), the EC 104, the GPU 154, a video/graphic display device 144 or other wired input/output devices 142 such as the stylus 148, a mouse 152, a keyboard 146, and a trackpad 150 and other components that may require power when a power button has been actuated by a user. In an embodiment, the PMU 122 may monitor power levels and be electrically coupled, either wired or wirelessly, to the backend coupled information handling system 100 to provide this power and coupled to bus 118 to provide or receive data or machine-readable code instructions. The PMU 122 may regulate power from a power source such as a battery 124 or AC power adapter 126. In an embodiment, the battery 124 may be charged via the AC power adapter 126 and provide power to the components of the backend coupled information handling system 100 via a wired connections as applicable, or when AC power from the AC power adapter 126 is removed. PMU 122 may include a hardware controller to operate with the EC 104 separately or together to execute machine-readable code instructions, parameters, and profiles 112 of the automatic peripheral device pairing management system pairing agent 156 on a backend coupled information handling system 100 or the automatic peripheral device pairing management system 158 on a backend management server information handling system 170 as described herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® Core class processor, ARM® brand processors, Qualcomm® Snapdragon processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

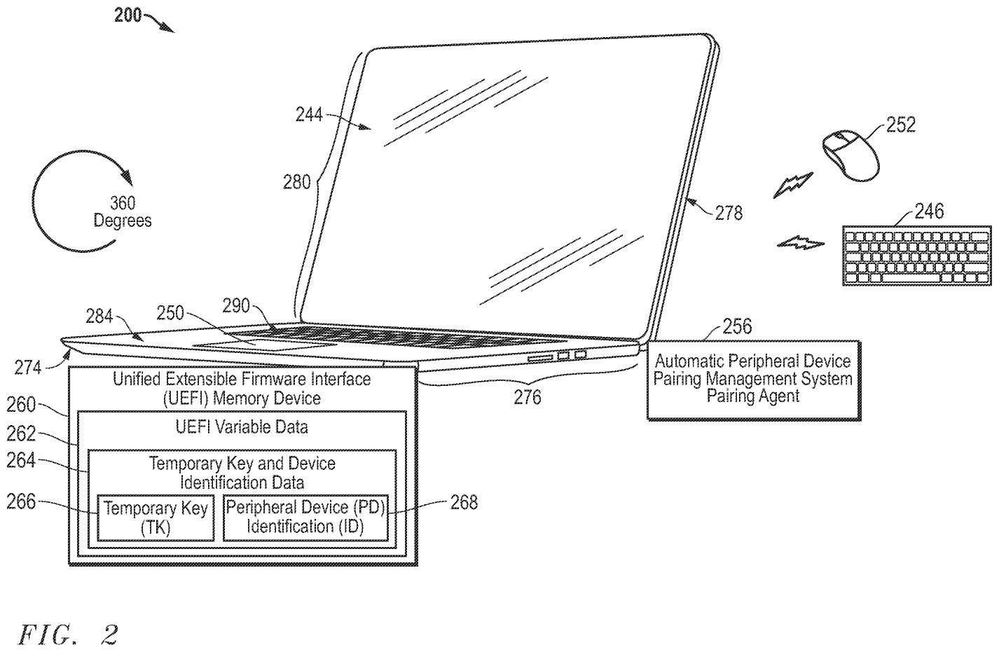

FIG. 2 is a graphic diagram of an backend coupled information handling system 200 and one or more wireless peripheral devices according to an embodiment of the present disclosure. In the embodiment shown in FIG. 2, the peripheral devices include a wireless mouse 252 and a wireless keyboard 246. However, it is appreciated that any type of peripheral device may be wirelessly coupled to the backend coupled information handling system 200 and may include any wireless input/output device 142 shown in FIG. 1 such as a video display device (e.g., external video display device), a stylus, a trackpad, and other similar devices.

The backend coupled information handling system 200 may, in an example embodiment, be a laptop-type backend coupled information handling system 200. The backend coupled information handling system 200 may, in an example embodiment, be a 360°-type backend coupled information handling system 200. In the example shown in FIG. 2, the backend coupled information handling system 200 may be a 360° backend coupled information handling system 200 where an exterior surface of the bottom cover or bottom chassis 274 of a base chassis 276 may be brought towards an exterior side of the back display chassis 278 of the display chassis 280 to place the backend coupled information handling system 200 in a tablet configuration in one embodiment. As shown in FIG. 2, the backend coupled information handling system 200 may also be placed in a laptop configuration where the base chassis 276 is lying flat on a surface with the display chassis 278 being placed upright from the base chassis 276. Other configurations such as a dual tablet configuration and a tent orientation are contemplated as described herein.

As described herein, the backend coupled information handling system 200 may include a plurality of chassis made of metal, plastic, or the like. The backend coupled information handling system 200, in an embodiment, may comprise an outer case or shell of an backend coupled information handling system 200 for housing internal components of the backend coupled information handling system 200, such as a video display device 244 (e.g., a built-in video display device 244), a cursor control device (e.g., built-in trackpad or touchpad 250), and an alpha numeric input device (e.g., built-in keyboard 282). As shown in FIG. 2, the backend coupled information handling system 200 may include a built-in video display device 244 functioning to enclose the display chassis 280 with the back display chassis 278 described herein.

As another example, the backend coupled information handling system 200 may further include the keyboard chassis 284 functioning to enclose a cursor control device such as a trackpad 250 and/or the built-in keyboard 290 acting as an alpha numeric input device. The back display chassis 278 and the video display device 244 may be joined together in an embodiment to form a fully enclosed display chassis 280, while the keyboard chassis 284 and a bottom chassis 274 may be joined together to form a fully enclosed base chassis 276. Taking a closed configuration as a reference position of the video display device 244 including the back display chassis 278 and the base chassis 276 including the keyboard chassis 284 and bottom chassis 274, the video display device 244 and back display chassis 278 may be rotated away from the base chassis 276 into the laptop configuration as shown in FIG. 2.

As described herein, the backend coupled information handling system 200 includes computer readable program code of an automatic peripheral device pairing management system pairing agent 256. When the computer readable program code of the automatic peripheral device pairing management system pairing agent 256 is executed by a hardware processing resource described herein an automatic querying, verification, and initiation of a BT pairing process may be completed according to the systems and methods described herein.

As described herein, the method of an automatic querying, verification, and initiation of a BT pairing process includes receiving, at the backend coupled information handling system 200, temporary key and device identification data 264 from a backend management server 270 by the automatic peripheral device pairing management system pairing agent 256. This process includes the backend coupled information handling system 200 being communicatively coupled to a backend management server (not shown) that hosts, in an embodiment, a backend management server database (not shown) used to store temporary keys 266 and peripheral device (PD) identifications (IDs) 268.

As described herein, in an embodiment, the temporary keys 266 and PD IDs 268 are stored on the backend management server database and are also assigned, by a hardware processor of the backend management server, to specific wireless PDs. In embodiment, the wireless PD ID 268 is provided to the backend management server 270 by a manufacturer (e.g., 176, FIG. 1) of the wireless PD being delivered to the user of the backend coupled information handling system 200. As described herein, the manufacturer may cause the PD ID 268 (e.g., a copy of the PD ID 268) to be stored on the memory device (e.g., non-volatile memory device) within the wireless PD, such as wireless mouse 252 prior to shipping of the wireless PD to the user or ITDM. In an embodiment, the PD ID 268 may be a serial number (e.g., a 12-digit serial number) or a randomly generated number that is unique to the specific wireless PD (e.g., wireless keyboard 246 or wireless mouse 252). In an embodiment, the manufacture also provides the temporary key 266 along with the PD ID 268 to the backend management server. In this example embodiment, the manufacturer executes, with a hardware processing resource, a random number generator, a hash function, a cryptographic hash function, or any other cryptographic key generating algorithm with some key seed data, such as a serial number or other seed data, that creates a unique temporary key 266 to be associated with the wireless PD and its PD ID 268. In another embodiment, after the backend management server 270 has received the PD ID 268 or some seed data from the manufacturer, a hardware processing resource of the backend management server 270 executes a random number generator, a hash function, a cryptographic hash function, or any other cryptographic key generating algorithm with the key seed data to create a unique temporary key 266 to be associated with the wireless PD and its PD ID 268.

Along with the PD ID 268, the manufacturer may provide purchasing data to the backend management server 270 identifying a purchaser who has purchased the wireless PD. Again, this data may include a street address of the purchaser, a name of the purchaser, a unique customer number, or any other identification data that allows the backend management server 270 to know who purchased the wireless PD that has the PD ID 268 and temporary key 266 associated with it. In an embodiment, the backend management server 270 may cross-reference this purchasing data identifying the purchaser with user data maintained by the backend management server database 272 on the backend management server 270. Where an identifying match between the purchaser and the user is determined, the backend management server 270 may be assigned to transmit, securely, the PD ID 268 and temporary key 266 to the user's backend coupled information handling system 200 or a backend coupled information handling system 200 assigned to the user.

In an embodiment, a single user may purchase the wireless PD from the manufacturer causing a single PD ID 268 and temporary key 266 set to be assigned to the specific wireless PD ordered by the user. In this embodiment, the backend management server 270 may transfer, securely, the PD ID 268 and temporary key 266 to that user's backend coupled information handling system 200. The transmission of the PD ID 268 and temporary key 266 to the user's backend coupled information handling system 200 may be accomplished by the backend management server 270, executing a software agent (e.g., Dell® SupportAssist®) that detects the online presence of the user's backend coupled information handling system 200 and initiates a data transfer session. In an embodiment, this data transfer conducted by the software agent includes the transfer, at least, of the temporary key 266 and PD ID 268. Concurrently, the manufacturer may ship the wireless PD (e.g., the wireless mouse 252 or wireless keyboard 246 in FIG. 2) to the user's address. Again, the wireless PD shipped by the manufacturer includes a matching PD ID 268 and temporary key 266 stored on non-volatile memory on the wireless PD.

In an embodiment, a ITDM of an enterprise or corporation may be assigned to be the purchasing agent for one or more users within that enterprise or corporation. The ITDM may, in an embodiment order a single wireless PD or a plurality of wireless PDs. In the example embodiment where the ITDM orders a plurality of wireless PDs, the wireless PDs may be assigned to one of a plurality of backend coupled information handling systems 200 operated by one or more of the users. In an embodiment, the PD IDs 268 and temporary keys 266 may not be assigned to specific wireless PDs that have been ordered by the ITDM. In this embodiment, a group of sets of PD IDs 268 and temporary keys 266 may be assigned to the group of wireless PDs ordered by the ITDM. Here, as the wireless PDs are shipped to the enterprise or corporation, the multiple sets of PD IDs 268 and temporary keys 266 may be provided to each potential backend coupled information handling system 200 as a temporary key and device identification data 264 package. However, each wireless PD shipped by the manufacturer includes one set of PD ID 268 and temporary key 266 that matches any one of the sets of PD IDs 268 and temporary keys 266 sent to each of the backend coupled information handling systems 200. As each user powers on a wireless PD given to them by the ITDM, each backend coupled information handling system 200 may have sufficient PD ID 268 and temporary key 266 data to pair with one of the wireless PDs. In an embodiment, even where multiple wireless PDs are powered on near a specific backend coupled information handling system 200, RSSI data may be used to select pairing the backend coupled information handling system 200 with the closest wireless PD as described herein.

In an alternative embodiment, the ITDM may be provide with access to the backend management server 270 in order to assign a specific wireless PD ordered by the ITDM to a specific backend coupled information handling system 200 within the enterprise or corporation. In an embodiment, the backend management server 270 may execute computer readable program code of a wireless PD assignment agent that allows the ITDM to assign a specifically ordered wireless PD to a specific backend coupled information handling system 200 within the enterprise or corporation. In this embodiment, because the specific PD ID 268 and temporary key 266 have been associated with a specific ordered wireless PD, only that wireless PD assigned by the ITDM to a specific backend coupled information handling system 200 may be paired with that backend coupled information handling system 200. In this embodiment, even where multiple wireless PDs (e.g., those wireless PDs ordered by the ITDM) are turned on near any given backend coupled information handling system 200, the PD ID 268 and temporary key 266 sent to the specific backend coupled information handling system 200 causes the backend coupled information handling system 200 to be paired to only one wireless PD that also includes, on its non-volatile memory device, the matching PD ID 268 and/or temporary key 266 as described herein. In an embodiment, the temporary key 266 may be a single use temporary key in some embodiments with a copy from the wireless PD by the manufacturer and a copy provided to the backend coupled information handling system 200. Because the temporary key 266 is a single-use temporary key, it is not used again after the pairing of the PD to the backend coupled information handling system 200 providing more security to the automatic querying, verification, and initiation of BT pairing process by using a newly, agreed-upon session key for the backend coupled information handling system to use to subsequently pair with the wireless PD. This allows a ITDM to order specific types of wireless PDs (e.g., a left handed mouse, a right handed mouse, an external keyboard that includes a ten-key input system, an external monitor that has sufficient resolution to be wirelessly paired with an information handling system, etc.) and assign those wireless PDs to not only specific backend coupled information handling systems 200 but to specific users who are intended to operate those backend coupled information handling systems 200.

In an embodiment, the individual backend coupled information handling systems 200 may request any potential PD ID 268 and temporary key 266 periodically. For example, a correlating software agent (e.g., Dell® SupportAssist® operating on the backend coupled information handling system 200) of the backend coupled information handling system 200 executed by a hardware processor may periodically send requests to the backend management server 270 for any potential PD ID 268 and temporary key 266 now assigned by the backend management server 270/ITDM to the user's backend coupled information handling system 200. In an embodiment, those backend coupled information handling systems 200 identified by the backend management server 270 as being associated with a specific user may be described as a backend coupled device that uses the software agent (e.g., Dell® SupportAssist®) to receive updates, software packages and the temporary key and device identification data 264 as described herein. Additionally, or alternatively, computer readable program code executed by a hardware processor on the backend management server 270 may detect that the backend coupled information handling system 200 is online and push the PD ID 268 and temporary key 266 to the backend coupled information handling system 200, again, with the execution of the software agent (e.g., Dell® SupportAssist®) by a hardware processor on the backend management server 270. As such the backend coupled information handling system 200 may be operatively coupled to the backend management server 270 via the network 236 using a wireless connection, a wired connection, or a combination of wired and wireless connections so that the PD ID 268 and temporary key 266 may be sent to and received at the backend coupled information handling system 200.

In an embodiment, as each of the backend coupled information handling systems 200 (e.g., the backend coupled information handling system 200 shown in FIG. 2) receives the temporary key and device identification data 264 (e.g., temporary key 266 and PD ID 268) the PD ID 268 and temporary key 266 may be stored in the UEFI memory device 260 as UEFI variable data 262. Again, in an embodiment, the UEFI memory device 260 may be any memory device that maintains the PD ID 268 and temporary key 266 for later retrieval by a Bluetooth stack under direction of a hardware processor (e.g., embedded controller, hardware CPU, hardware GPU, etc.). In an embodiment, the Bluetooth stack includes computer executable program code with hardware that, when executed by a hardware processor (e.g., hardware processor 202, embedded controller 204, CPU, GPU, or any other hardware processing resource) along with execution of the automatic peripheral device pairing management system pairing agent, performs automatic querying, verification, and BT pairing initiating operations between the backend coupled information handling system 200 and wireless PD. The OS BT stack also accesses the UEFI variable data 262 for future pairing processes, and controls operations of a Bluetooth radio 230-2, among other functions. A plurality of protocols may be present in the Bluetooth stack which may include core protocols (e.g., computer executable program code executed by a hardware processing resource) including Bluetooth radio, baseband, link manage protocol, logical link control and adaptation protocol, and service discovery protocols. The Bluetooth stack protocols may also include cable replacement protocols such as radio frequency communication protocols. Still further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 130-2, FIG. 1) housed within the backend coupled information handling system 200 used to transmit radio waves at a specific frequency as described herein.

The frequency with which the Bluetooth stack of the Bluetooth radio queries the UEFI variable data 262 to determine if temporary key and device identification data 264 is available may vary. In an embodiment, the Bluetooth stack may query the UEFI memory device 260 for the UEFI variable data 262 during every power up of the backend coupled information handling system 200. In an embodiment, the Bluetooth stack may query the UEFI variable data 262 on the UEFI memory device 260 a plurality of times when the backend coupled information handling system 200 is powered up.

As the backend management server 270 receives the temporary key and device identification data 264 from the manufacturer of the wireless PD, the manufacturer of the wireless PD may ship the wireless PD to the user (e.g., ITDM or user of the backend coupled information handling system 200). The shipping of the wireless PD to the end user (e.g., a single user or an ITDM and enterprise or corporation) may happen currently as the backend management server 270 correlates the PD ID 268 and a generated temporary key 266 with the user's identity (or ITDM and enterprise's or corporation's identity) and the backend coupled information handling system 200 operated by the user. Thus, in an embodiment, the temporary key and device identification data 264 may be relayed to the backend coupled information handling system 200 prior to the user receiving, via shipment, the wireless PD. This allows the automatic peripheral device pairing management system pairing agent 256 to, with the Bluetooth stack, retrieve the temporary key 266 and PD ID 268 in preparation for pairing the wireless PD (e.g., a wireless mouse 252) with the backend coupled information handling system 200.

As the user receives the wireless PD from the manufacturer, the user may power up the wireless PD. In the example of the wireless mouse 252 or the wireless keyboard 246 shown in FIG. 2, this may include moving a power switch on the wireless PD to an on position. The powering on of the wireless PD causes the wireless PD to broadcast a pairing query signal that includes a pairing request on an OOB BT broadcast communication channel. In the embodiments herein, this broadcast the pairing query signal from the wireless PD includes the PD ID 268 stored in the non-volatile memory device by the manufacturer as described herein. As described herein, the PD ID 268 was stored on the non-volatile memory device on the wireless PD by the manufacturer in preparation for this querying, verification, and BT pairing process.

The Bluetooth stack associated with the Bluetooth radio of the backend coupled information handling system 200 and execution of code instructions of the automatic peripheral device pairing management system pairing agent may detect this PD ID 268 from the wireless PD and compare it to the PD ID 268 received from the backend management server 270. Again, the PD ID 268 stored in the UEFI memory device 260 of the backend coupled information handling system 200 and accessed by the Bluetooth stack may include a plurality of PD IDs 268 and temporary keys 266 in those embodiments where the ITDM has ordered a plurality of wireless PDs for any given user to use and simply passes one of the plurality of ordered PDs to the user of a backend coupled information handling system 200 so any of several wireless PDs may be automatically paired. Where a single wireless PD has been ordered by the user, the UEFI memory device 260 of the user's backend coupled information handling system 200 may store a single PD ID 268 (and temporary key 266).

Where the PD ID 268 provided by the wireless PD device does not match the PD ID 268 accessed by the Bluetooth stack of the Bluetooth radio 230-2 at the UEFI memory device 260, the pairing process is prevented from continuing. Where the PD ID 268 provided by the wireless PD matches the PD ID 268 or at least one of the PD IDs 268 stored in the UEFI memory device 260, the automatic verification and initiation of the BT pairing process may proceed.

In an embodiment, the Bluetooth stack of the Bluetooth radio 230-2 may request certain received signal strength indicator (RSSI) value data from the wireless PD. RSSI data transmitted includes the power level being received by the receiving radio at the wireless PD (e.g., after calculated antenna and cable loss). This RSSI signal data received by the wireless interface adapter 228 indicates whether, in an embodiment, the wireless PD is within a threshold range of the backend coupled information handling system 200 based on meeting an RSSI threshold. In the embodiment where multiple wireless PDs had been ordered by a ITDM to be paired with any of a plurality of backend coupled information handling systems 200, the RSSI threshold data may prevent other wireless PDs that are not within a threshold distance of the user's backend coupled information handling system 200 form being paired with the backend coupled information handling system 100. Additionally, or alternatively, where multiple wireless PDs had been ordered by a ITDM to be paired with any of a plurality of backend coupled information handling systems 200, the RSSI threshold data may prevent multiple wireless PDs from being paired with a backend coupled information handling system 200 by detecting the wireless PD with the highest RSSI value and pairing with that wireless PD instead of those wireless PDs that have lower RSSI values. Such as situation may occur especially where two employees of an enterprise are to be given wireless PDs to pair with their respective backend coupled information handling systems 200 and they are within close proximity to each other during the pairing process (e.g., cubicle neighbors, desk mates, etc.) of their received wireless PDs. In an embodiment, the RSSI value provided by the wireless PD may be compared to a RSSI threshold value set at the Bluetooth radio 230-2 as well. Where the detected wireless mouse 252 RSSI value does not meet or exceed the RSSI threshold value, the backend coupled information handling system 200 may ignore the pairing request of the wireless PD. Where the RSSI value meets or exceeds the RSSI threshold value, the Bluetooth stack of the Bluetooth radio 230-2 and the automatic peripheral device pairing management system pairing agent 256 may continue the automatic verification and initiation of the BT pairing process with only that wireless PD that has the highest RSSI value. This prevents multiple wireless PDs from incorrectly being paired with any single backend coupled information handling system 200.

The automatic verification and initiation of the BT pairing process, in an embodiment, is executed by code instructions of the automatic peripheral device pairing management system pairing agent 256 and includes the backend coupled information handling system 200 comparing received temporary key at the backend coupled information handling system 200 with the copy PD temporary key stored at the wireless PD 242 attempting to BT pair. In an embodiment, the automatic verification and initiation of the BT pairing process may use a Bluetooth out-of-band (OOB), a legacy Bluetooth Low Energy (BLE) OOB pairing, a Bluetooth Low Energy (BLE) OOB Pairing protocol, or any other suitable protocol to verify and then to BT pair the wireless PD to the backend coupled information handling system 200. In an embodiment, the backend coupled information handling system 200 and wireless PD can each provide various automatic querying, verification, and BT pairing communications that includes the temporary key 266 and a pairing response command via an OOB BT communication. In an embodiment, the backend coupled information handling system 200 may calculate an Mconfirm value from its copy of the temporary key via a cipher algorithm such as a confirm value generation function (e.g., a 128-bit random number Mrand, the temporary key, and other pairing data), provide an encrypted Mconfirm to the wireless PD, and receive a calculated Sconfirm (e.g., a 128-bit random number Srand, the temporary key, and other pairing data) from the wireless PD that calculated a PD Sconfirm value from its own stored copy of the PD temporary key and the confirm value generation function. This encrypted Sconfirm may be decrypted at the backend coupled information handling system. A match the received Sconfirm from the wireless PD as well as the calculated Sconfirm in the backend coupled information handling system 200 may be used as verification. Where the values match (e.g., the Mrand and Srand as well as the temporary keys 266 passed between the wireless PD and the backend coupled information handling system 200), the BT pairing process establishes a session key and a BT wireless link via the OS BT stack and BT protocols. Then the BT pairing process is completed between the wireless PD and backend coupled information handling system 200. In an embodiment, once the wireless PD is paired with the backend coupled information handling system 200, the temporary key is no longer used and may be deleted. In an embodiment, the temporary key may be a single use temporary key in some embodiments with a copy stored on the wireless PD by the manufacturer and a copy provided to the backend coupled information handling system 200 as described in embodiments herein and which are destroyed after verification of touchless BT pairing is to be initiated.

The systems and methods described herein allows for a secure method of automatically querying, verifying, and initiating of the BT pairing of a wireless PD such as a wireless mouse 252. The method allows a backend coupled information handling system 200 to receive a temporary key 266 and PD ID 268 pair that is to be matched with a matching temporary key 266 and PD ID 268 stored on the wireless PD when the wireless PD initiates a pairing request. As such the temporary key 266 is secured and controlled by the backend management server 270 that has an existing relationship with a backend coupled computing device such as the backend coupled information handling system 200 as well as access to identifying data for the wireless PD from a manufacturer described herein. Additionally, the PD ID 268 and a copy PD temporary key 266 are secured on the non-volatile memory device on the wireless PD with the temporary key 266 only being shared when the wireless PD and backend coupled information handling system 200 are automatically queried and verified with the automatic peripheral device pairing management system pairing agent 256 before being BT paired together using an OOB BT communication channel.

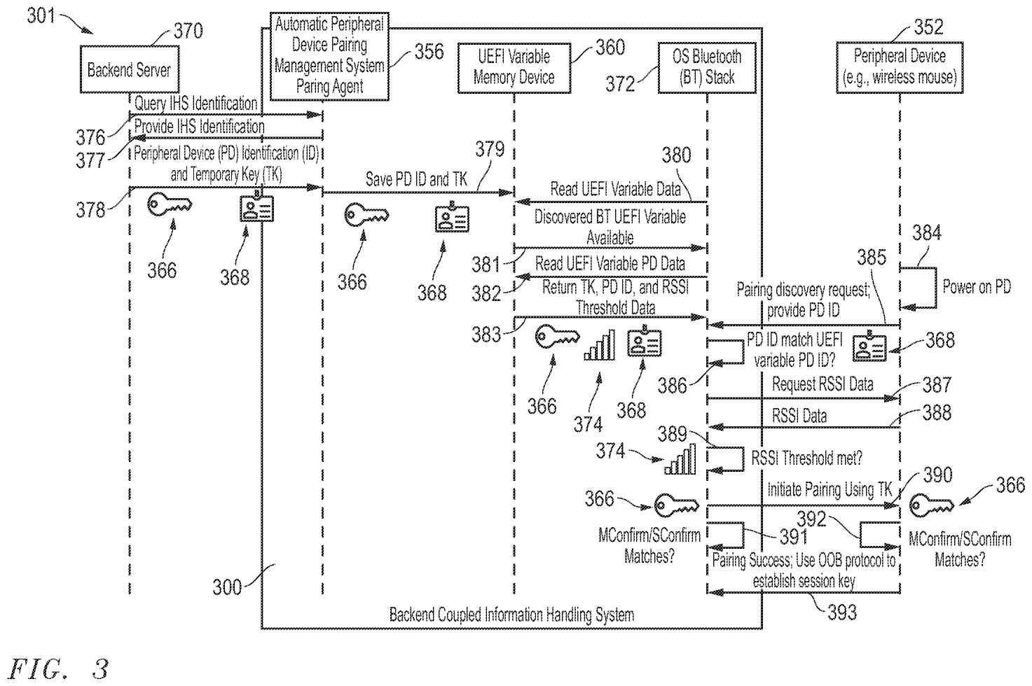

FIG. 3 is a process flow diagram of a method 301 of operatively pairing a BT peripheral device 352 to a backend coupled information handling system 300 according to an embodiment of the present disclosure. In the context of the FIG. 3, the peripheral device 352, in one example, will be referred to as a wireless mouse although the present specification contemplates that any wireless peripheral device 352 may be used in the method 301 described herein. FIG. 3 shows a backend management server 370, a backend coupled information handling system 300, and a wireless peripheral device 352 where execution of code instructions of an automatic peripheral device pairing management system at 370 and its pairing agent 258 and operating system (OS) BT stack 370 at the backend coupled information handling system 300 coordinate to pair the peripheral device 352 to the backend coupled information handling system 300 backend coupled by the backend management server 370.

The method 301 includes the backend management server includes a backend management server database (not shown) that maintains one or more sets of PD IDs 368 and temporary keys 366 for wireless peripheral devices ordered by an enterprise or customers of a backed management system. Each PD ID 368 and temporary key 366 set may correspond with an individual and specific peripheral device such as a wireless mouse. The PD ID 368 and temporary key 366 are assigned to a specific peripheral device 352 because the backend management server 370, via execution of computer readable program code of a software system (e.g., Dell® SupportAssist®) including an automatic PD pairing management system of embodiments herein by a hardware processor, has determined that the ordered peripheral device 352 was ordered by a user of the backend coupled information handling system 300. As described herein, the manufacturer of the peripheral device 352 may forward, at least, the PD ID 368 associated with the peripheral device 352 to the backend management server. In an embodiment, the PD ID 368 may be a serial number or other identification data assigned by the manufacturer to the specific wireless PD during the manufacturing process. The temporary key 366 may be any key that is created by one of the backend management server 370 or the manufacturer. Where the manufacturer creates the temporary key 366, it too may be forwarded onto the backend management server 370 along with the PD ID 368 assigned to the specific peripheral device 352. Where the backend management server 370 creates the temporary key 366, the backend management server 370 associates the temporary key 366 with the PD ID 368 on the backend management server database and forwards the temporary key 366 to the manufacturer for association with the PD ID 368 for the ordered wireless peripheral device 352. At this point, the manufacturer uploads the PD ID 368 and temporary key 366 specific to that peripheral device 352 to a non-volatile memory device on the peripheral device 352 for shipment to the user of the backend coupled information handling system 300. In one embodiment, the manufacturer or backend management server 370 executes, with a hardware processing resource, a random number generator, a hash function, a cryptographic hash function, or any other cryptographic key generating algorithm that creates a unique temporary key 266 to be associated with the wireless PD 352 and its PD ID 368. In an embodiment, the PD ID 368, such as a full or partial serial number or other identifying data of a PD 352, may be used as seed data used with or without the executed random number generator, in a hash function, a cryptographic hash function, or any other cryptographic key generating algorithm to generate the temporary key 366. This allows the generated temporary key 366 to be unique to the peripheral device 352 it is assigned to and placed on the non-volatile memory device of the peripheral device 352. Further the temporary key 366 may be a single use key in some embodiments with a copy provided to the wireless PD 352 by the manufacturer and a copy provided to the backend coupled information handling system 300 via the automatic PD pairing management system and pairing agent 356.

As described herein, the backend management server 370 may manage one or more backend coupled information handling systems 300. For example, the backend management server 370 may execute a software agent (e.g., Dell® SupportAssist®) that operatively couples the backend management server 370 with the backend coupled information handling system 300 to treat the backend coupled information handling system 300 as a backend coupled information handling system 300. With this management of the backend coupled information handling system 300, the backend management server 370 may establish a communication with the information handling system (IHS) 300 by querying the backend coupled information handling system 300 based on the identification of the backend coupled information handling system 300 at 376. In an embodiment, the backend coupled information handling system 300 may also include a software agent (e.g., Dell® SupportAssist®) that allows the backend coupled information handling system 300 to communicate with the backend management server 370 whenever the backend coupled information handling system 300 has established a wired or wireless connection with the backend management server 370. When the backend coupled information handling system 300 establishes this connection with the backend management server 370, the query at line 376 is responded to by the backend coupled information handling system 300 at line 377 with the identification of the backend coupled information handling system 300, for example, a PDID 368 a serial number of the backend coupled information handling system 300. In an embodiment, the backend management server 370, upon receiving the identification data of the backend coupled information handling system 300, may cross-reference this identification data with a user identification on the backend management server database. This user identification and backend coupled information handling system 300 identification data may establish management communications with the backend coupled information handling system. The backend management server 370 may execute code instruction, with a hardware processor of an automatic peripheral device pairing management system, and use the backend coupled information handling system 300 identification data received to determine if the user had recently purchased the peripheral device 352. As described herein, the manufacturer of the peripheral device 352 may provide purchasing data to the backend management server 370 describing the purchaser of the peripheral device 352 as well as identification of the purchased wireless PD 352. For example, where John Smith has purchased a wireless mouse on a third-party website or directly from the manufacturer, the manufacturer may forward the PD ID 368, the purchaser's name, enterprise name, or other identification, purchasing data such as time of purchase information, a street address, and the like to the backend management server 370. This identification data may be used by the backend management server 370 to determine if the user of the information handling system is a user of a backend coupled information handling system 300 being backend coupled by the backend management server 370. Where the identification data of the backend coupled information handling system 300 matches the user's data and the purchasing data matches the user's data, the backend management server 370, at line 378, provides the PD ID 368 and temporary key 366 associated with the purchased peripheral device 352 to the automatic peripheral device pairing management system pairing agent 358 at the backend coupled information handling system 300. The delivery of the PD ID 368 and temporary key 366 of the temporary key and device identification data is conducted using a secure link between the backend server 370 and the backend coupled information handling system 300 to prevent this data from being stolen by an intermediary third party. This secure link may include a tunneling protocol that includes encryption of data packets (e.g., that includes secure application layers, secure transport layers, and the like) to prevent use of the temporary key 366 and/or PD ID 368 by an intermediary third party.

In an embodiment, the automatic peripheral device pairing management system pairing agent 356 described herein receives the PD ID 368 and temporary key 366. As described herein, the automatic peripheral device pairing management system pairing agent 356 may be computer readable program code executable by a hardware processing resource that controls the transmission and storage of the PD ID 368 and temporary key 366 at the backend coupled information handling system 300. At line 379, the automatic peripheral device pairing management system pairing agent 356 provides instructions to a hardware processing resource (e.g., hardware processor, embedded controller, GPU CPU, etc.) to store the temporary key and device identification data that includes the PD ID 368 and temporary key 366 in a UEFI memory device 360 in an embodiment. The UEFI memory device 360 may be any memory device that maintains the PD ID 368 and temporary key 366 for later retrieval by an operating system (OS) Bluetooth (BT) stack 372 under direction of a hardware processor executing code instructions of the automatic peripheral device pairing management system pairing agent 356 to conduct discovery, verification, and initiation of a BT pairing process with the wireless PD 352. The UEFI memory device 360 may be accessible to the BIOS and/or OS of the backend coupled information handling system 300 and maintained securely in order to prevent the PD ID 368 and temporary key 366 from being used by other backend coupled information handling systems to pair with the peripheral device 352.

The OS BT stack 372 includes computer executable program code with hardware that, when executed by a hardware processor (e.g., a hardware processor, an embedded controller, or any other hardware processing resource) an under control of the automatic peripheral device pairing management system pairing agent 356, accesses the UEFI variable data on the UEFI memory device 360 for future automatic pairing process discovery, verification, and initiation between the backend coupled information handling system 300 and the peripheral device 352. Upon discovery and verification of the wireless PD 352, the OS BT stack 372 may perform pairing operations between the backend coupled information handling system 300 and the peripheral device 352 with a session key, and controls operations of a Bluetooth radio (not shown) in order to conduct that pairing operation, among other functions to establish a secure BT wireless link. A plurality of protocols may be present in the OS BT stack 372 which may include core protocols including Bluetooth radio, baseband, link manage protocol, logical link control and adaptation protocol, and service discovery protocols. Still further, the protocols present with the OS BT stack 372 include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the OS BT stack 372. Physical layers of the OS BT stack 372 also include a radio (e.g., Bluetooth radio 130-2, FIG. 1) used to transmit radio waves at a specific frequency as described herein for establishing the BT wireless link for operation of the wireless PD 352 with the backend coupled information handling system 300 upon pairing.

The OS BT stack 372 of the Bluetooth radio queries the UEFI variable data stored on the UEFI memory device 360 on the backend coupled information handling system 300 to determine if temporary key 366 and PD ID 368 is available as directed via the automatic peripheral device pairing management system pairing agent 356. In an embodiment, the OS BT stack 372 may query the UEFI memory device 360 for the UEFI variable data during every power up of the backend coupled information handling system 300. In an embodiment, the OS BT stack 372 may query the UEFI variable data on the UEFI memory device 360 a plurality of times when the backend coupled information handling system 300 is powered up in some embodiments.

Therefore, at line 380, the OS BT stack 372 reads the UEFI variable data from the UEFI memory device 360. This is done so as to discover whether temporary key and device identification data that includes, at least, the temporary key 366 and PD ID 368 has been stored on the UEFI memory device 360. At line 381, a notice from a hardware processing device operating the UEFI memory device 360 may indicate that a temporary key 366 and PD ID 368 set has been stored on the UEFI memory device 360. It is appreciated, however, that where no temporary key and device identification data has been stored on the UEFI memory device 360, the hardware processor may similarly indicate that it does not exist to the OS BT stack 372, and the OS BT stack 372 may be required to conduct manual BT pairing under regular, manual BT pairing processes. However, as described in lines 378 and 379, in this example embodiment, the UEFI memory device 360 has received the temporary key and device identification data (e.g., the temporary key 366 and PD ID 368 associated with the peripheral device 352).

When the OS BT stack 372 has been notified that the temporary key and device identification data is present on the UEFI memory device 360, the OS BT stack 372 may then request that temporary key and device identification data including the temporary key 366 and PD ID 368 form the UEFI memory device 360 at line 382. In an embodiment, along with the temporary key 366 and PD ID 368, the UEFI memory device 360 may store RSSI threshold data 374. RSSI data includes data describing the signal power level threshold at which a wireless BT signal is being received by the receiving BT radio from the wireless PD 352 (e.g., after calculated antenna and cable loss) is sufficient to select that wireless PD 352 for discovery, verification, and initiation of the automatic BT pairing. The RSSI threshold data 374 received by from the UEFI memory device 360 indicates whether, in an embodiment, a wireless PD 352 that is broadcasting for discovery is within a threshold range of the backend coupled information handling system 300. In the embodiment where multiple peripheral devices 352 had been ordered by a ITDM to be paired with any of a plurality of backend coupled information handling systems 300, the RSSI threshold data 374 may prevent other peripheral devices 352 that are not within a threshold distance of the user's backend coupled information handling system 300 from being paired with the backend coupled information handling system 300 used by the user. Additionally, or alternatively, where multiple peripheral devices 352 had been ordered by a ITDM to be paired with any of a plurality of backend coupled information handling systems 300, the RSSI threshold data 374 may prevent multiple peripheral devices 352 from being paired with a backend coupled information handling system 300 by detecting the peripheral device 352 with the highest detected RSSI value and discovery, confirming, and initiating pairing with that peripheral device 352 instead of those peripheral devices 352 that have lower detected RSSI values. Such as situation may occur especially where two employees of an enterprise are to be given peripheral devices 352 to pair with their respective backend coupled information handling systems 300 and they are within close proximity to each other during the discovery, confirming, and initiating pairing process (e.g., cubicle neighbors, desk mates, etc.) of their received peripheral devices 352. In an embodiment, the RSSI value provided by the wireless peripheral device 352 may be compared to the RSSI threshold data 374 set at the UEFI memory device 360 and monitored by the Bluetooth radio as well. Where the detected peripheral device 352 RSSI value does not meet or exceed the RSSI threshold value of the RSSI threshold data 374, the backend coupled information handling system 300 may ignore the pairing discovery request, BT pairing broadcast discovery signal, and any other pairing data of the peripheral device 352. Where the detected RSSI value of the detected peripheral device 352 meets or exceeds the RSSI threshold value of the RSSI threshold data 374, the OS BT stack 372 of the Bluetooth radio may begin the discovery, confirmation, and initiation of the BT pairing process with only that peripheral device 352 that has the highest RSSI value and the OS BT stack 372 and execution of code instructions of the automatic peripheral device pairing management system pairing agent 356. This prevents multiple peripheral devices 352 from redundantly being paired with any single backend coupled information handling system 300 as well as preventing those peripheral devices 352 that were not intended to be paired with the backend coupled information handling system 300 from initiating pairing.

At line 384, the user may activate or otherwise turn on the peripheral device 352. This process may be conducted while or after the temporary key 366, PD ID 368, and RSSI threshold data 374 has been received by the OS BT stack 372 from the UEFI memory device 360. Once activated, the peripheral device 352 may broadcast a pairing discovery request on a broadcast OOB BT discovery channel. The pairing discovery request includes the PD ID 368 at line 385. The broadcasting of the PD ID 368 for pairing with the backend coupled information handling system 300 may be conducted via a Bluetooth radio (not shown) and BT stack (not shown) of the peripheral device 352 in an OOB BT communication on an OOB BT broadcast channel as instructed by a hardware processing resource (not shown) on the peripheral device 352. In an embodiment, a hardware controller (not shown) on the peripheral device 352 controls the execution of computer readable program code used to initiate the Bluetooth radio and broadcast pairing discovery requests with a PD ID 368 at 385 on the OOB BT broadcast channel to initiate and conduct the pairing process described herein. Concurrently, the OS BT stack 372 along with a Bluetooth radio may monitor for this broadcasting at line 385 for the backend coupled information handling system 300.

Pursuant to execution of code instructions of the automatic peripheral device pairing management system pairing agent 356, at line 386, the OS BT stack 372 may engage in verifying whether the PD ID 368 received from the broadcast by the peripheral device 352 matches the PD ID 368 received from the backend management server 370, stored on the UEFI memory device 360, and accessed by the OS BT stack 372 of the backend coupled information handling system 300. Where the PD ID 368 from the broadcast of the peripheral device 352 does not match the PD ID 368 accessed by the OS BT stack 372, the pairing request from the peripheral device 352 is ignored, prevented, or otherwise disregarded unless other pairing processes are initiated. In an embodiment, the non-matching of the PD ID 368 from the broadcast of the peripheral device 352 and the PD ID 368 accessed by the OS BT stack 372 may indicate that that particular peripheral device 352 has not been assigned to that particular backend coupled information handling system 300 or that the particular peripheral device is unknown to the backend management server 370 and did not receive temporary key and device identification data related to the peripheral device. In another example embodiment, the ITDM may have accessed the backend management server 370 via the software agent (e.g., Dell® SupportAssist®) and assigned specific peripheral devices 352 to specific backend coupled information handling systems 300 within an enterprise or corporation and the currently broadcasting peripheral device 352 with the unmatched PD ID 368 had not been assigned to the backend coupled information handling system 300 shown in FIG. 3. In some embodiments, the wireless PD 352 may still be manually paired via the OS BT stack 372 using regular BT pairing protocols. It is also appreciated that multiple sets of temporary keys 366 and PD IDs 368 may have been saved in the UEFI memory device 360 and accessed by the OS BT stack 372 in an embodiment. Here, the mismatch of the broadcasted PD ID 368 from the peripheral device 352 may indicate that the peripheral device 352 was not assigned to the particular backend coupled information handling system 300. Thus, the user may be prompted to try another peripheral device. Potentially, the wireless PD 352 was not assigned to any particular backend coupled information handling system 300 within the enterprise or corporation and may not be pairable or may require manual pairing in various embodiments.

Where, at line 386, the PD ID 368 broadcasted by the peripheral device 352 matches the PD ID 368 accessed by the OS BT stack 372, the automatic verification and initiation of the BT pairing process may continue with the OS BT stack 372 requesting RSSI test transmission data from the peripheral device 352 at line 387. Again, detecting the RSSI levels may determine whether the peripheral device 352 is close enough to be paired with the backend coupled information handling system 300. At line 388, the peripheral device 352 may broadcast, wirelessly, and the BT radio at the backend coupled information handling system 300 determines the RSSI level that describes the power level being received by the receiving BT radio of backend coupled information handling system 300 from the wireless PD (e.g., after calculated antenna and cable loss). In those examples where an ITDM has ordered a plurality of peripheral devices 352 to be wirelessly paired with any of a plurality of backend coupled information handling systems 300 within the enterprise or corporation, the RSSI data transmission levels provided from the peripheral device 352 may prevent simultaneous pairing of multiple peripheral devices 352 used that only meet the RSSI threshold level 374 with the backend coupled information handling system 300 shown in FIG. 3 based on wireless range.

At line 389, the OS BT stack 372, under direction of a hardware processing device, may compare the RSSI levels received from the peripheral device 352 to the RSSI threshold data 374 received from the UEFI memory device 360. Where the RSSI level received from the peripheral device 352 meets or exceeds the RSSI threshold data 374, the automatic verification and initiation of the BT pairing process continues with the automatic peripheral device pairing management system pairing agent 356 instructing the OS BT stack 372 of the backend coupled information handling system 300 and the peripheral device 352 to compare temporary keys 366 used to establish the regular BT communication channel used to securely pair the peripheral device 352 to the backend coupled information handling system 300. If the temporary keys 366 match at 391 and 392 as determined at the backend coupled information handling system 300 and wireless PD 352, the verification of pairing success is confirmed at 393 and a session key is used to establish a BT wireless link. In an embodiment, the backend coupled information handling system 300 and peripheral device 352 may, at lines 391 and 392, calculate an Mconfirm value, provide the Mconfirm value to the other device, and receive a calculated Sconfirm from the other device. Where the values match (e.g., Mconfirm=Sconfirm), the pairing process is completed between the peripheral device 352 and backend coupled information handling system 300 at line 393. In an embodiment, once the peripheral device 352 is paired with the backend coupled information handling system 300, the temporary key 366 is no longer used. With this temporary key 366 verification at the backend coupled information handling system 300 and wireless PD 352, the OS BT stack 372 may finish conducting BT pairing with a session key pursuant to BT pairing standards. With the session key, a BT wireless link is established between the backend coupled information handling system 300 and wireless PD 352 for use of the wireless PD 352.

Again, in an embodiment, the pairing process may use a Bluetooth OOB pairing protocol, a legacy BLE OOB pairing protocol, a BLE OOB Pairing protocol, or any other suitable protocol to pair the peripheral device 352 to the backend coupled information handling system 300 and may be discarded or deleted. Additionally, in an embodiment, the pairing of the backend coupled information handling system 300 with the peripheral device 352 includes the backend coupled information handling system 300 and peripheral device 352 establishing session keys thereby providing a secure BT wireless link for securely communicating and pairing with each other. At this point the method 301 ends with the backend coupled information handling system 300 and peripheral device 352 being paired until one or both are powered down.

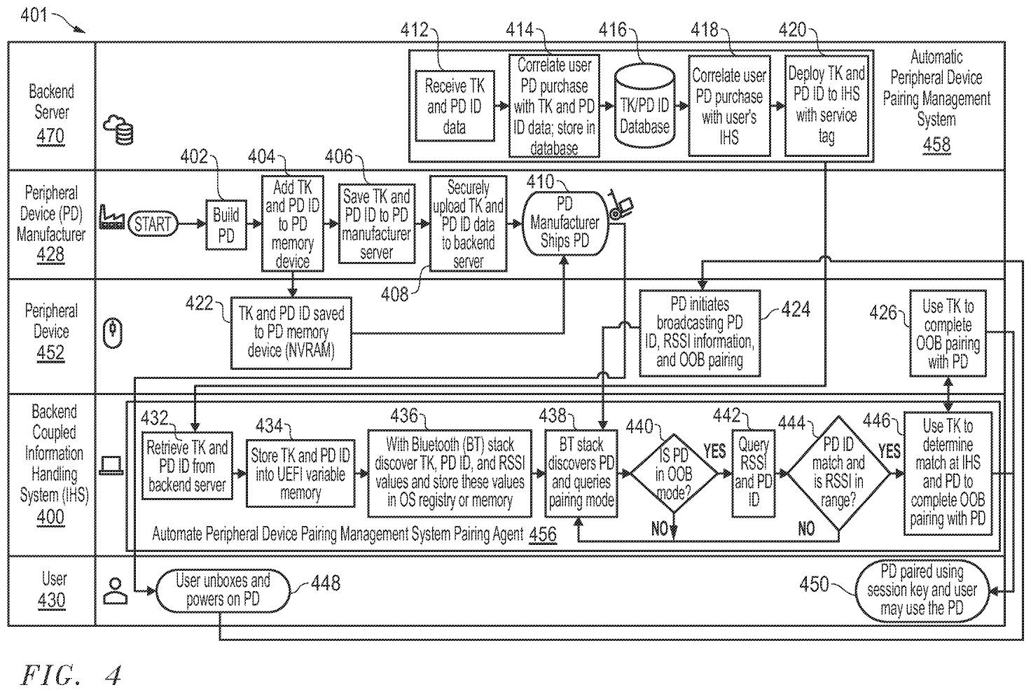

FIG. 4 is another process flow diagram of a method 401 of assigning a peripheral device 452 with a backend coupled information handling system 400 and automatically discover, verify, and initiate BT pairing of that peripheral device 452 to the backend coupled information handling system 400 according to an embodiment of the present disclosure. FIG. 4 shows a number of devices and entities operating together to coordinate automatic discovery, verification, and initiation of BT pairing of the backend coupled information handling system 400 with the peripheral device 452 securely via execution of code instructions of an automatic peripheral device pairing management system 458 and an automatic peripheral device pairing management system pairing agent 456.

In an embodiment, the method 401 may start with a wireless PD manufacturer 428 building the peripheral device 452 at block 402. In an embodiment, the wireless PD manufacturer 428 may be any manufacturer and may be part of the corporation or entity that operates the backend management server 470. Alternatively, the wireless PD manufacturer 428 may be a different entity than the entity that operates the backend management server 470 with the wireless PD manufacturer 428 and the operator of the backend management server 470 having a business relationship as described herein.

As described herein, the peripheral device 452 manufactured by the wireless PD manufacturer 428 may be any type of wireless peripheral device 452 that is to be paired with the backend coupled information handling system 400. In an embodiment, the peripheral device 452 may be a wireless mouse, a wireless keyboard, a wireless external monitor, a wireless trackpad, a wireless 10-key pad, a wireless digital pen, and the like. For case of understanding, one example wireless peripheral device described in connection with FIG. 4 may be described as a wireless mouse. However, the present specification contemplates that the principles described herein equally apply to any type of wireless peripheral device 452.

During the manufacturing process of the peripheral device 452 at 402, the wireless PD manufacturer 428 may assign a PD ID to the peripheral device 452. In an embodiment, the PD ID assigned to the peripheral device 452 may be a serial number or other unique identification that allows each particular peripheral device 452 to be distinguished from all other peripheral device manufactured by the wireless PD manufacturer 428. It is appreciated, however, that other identification data may be used as the PD ID apart from a serial number and the present specification contemplates those other types of identification data used to uniquely identify the peripheral device 452 via a PD ID.

At block 404, the wireless PD manufacturer 428 may add the PD ID to a memory device of the peripheral device 452. In an embodiment, the memory device may be any type of non-volatile memory device that securely maintains the PD ID prior to pairing with the backend coupled information handling system 400 as described herein. Along with the PD ID, the wireless PD manufacturer 428 may cause a temporary key to be stored on the non-volatile memory of the peripheral device 452. In an embodiment, the manufacturer may execute, with a hardware processing resource, a random number generator, a hash function, a cryptographic hash function, or any other cryptographic key generating algorithm that creates a unique temporary key to be associated with the peripheral device 452 and its assigned PD ID and stored on the wireless PD 452. In an embodiment, the PD ID may be used as seed data used by the executed random number generator, a hash function, a cryptographic hash function, or any other cryptographic key generating algorithm to generate the temporary key. This allows the generated temporary key to be unique to the peripheral device 452. Alternatively, the operator (e.g., Dell® Incorporated) of the backend management server 470 may generate and provide the unique temporary key to the wireless PD manufacturer 428 of manufactured wireless PDs 452 purchased for and assigned to backend coupled information handling systems 400 as notification of those wireless PDs 452 is provided to the backend management server 470. The wireless PD 452 manufacturer 428 may then store any received temporary keys at 404 in storage on the non-volatile memory device at 422 of the peripheral device 452. In an embodiment, the operator of the backend management server 470 may execute, with a hardware processing resource at the backend management server, a random number generator, a hash function, a cryptographic hash function, or any other cryptographic key generating algorithm that creates the unique temporary key to be associated with the peripheral device 452 and its assigned PD ID. In an embodiment, the PD ID received from the wireless PD manufacturer 428 wireless PD manufacturer 428 at the backend management server 470 may be used as seed data by the executed random number generator, hash function, cryptographic hash function, or any other cryptographic key generating algorithm to generate the temporary key. In an embodiment, the operator of the backend management server 470 may then send the generated temporary key back to the wireless PD manufacturer 428 for the wireless PD manufacturer 428 to include it with the PD ID on the non-volatile memory at 422 of the peripheral device 452. Therefore, at block 404, the generated temporary key is also assigned to the peripheral device 452. The PD ID and generated temporary key are placed on the non-volatile memory device (e.g., non-volatile random access memory device) at 422 of the peripheral device 452.

At block 406, the wireless PD manufacturer 428 may save the PD ID and temporary key set assigned to each peripheral device 452 on a data storage device associated with the wireless PD manufacturer 428. This is done so that, as each peripheral device 452 is purchased, the wireless PD manufacturer 428 may have access to the PD ID and temporary key assigned to each individual peripheral device 452.

As each of the individual peripheral devices 452 are sold by the wireless PD manufacturer 428, the wireless PD manufacturer 428 may, at block 408, securely upload a copy of the temporary key and PD ID data to the backend management server 470. The secure connection between the database associated with the wireless PD manufacturer 428 and the backend management server 470 may include any type of security protocols including hypertext transfer protocol secure (HTTPS) using transport layer security (TLS) protocols and the like. This layer of security prevents third parties from gaining access to the PD ID and temporary key as well as other data described herein. In an example embodiment, further data accompanying the copy of the PD ID may include data describing the purchaser/user. The data describing the purchaser/user may include a street address, purchase date, a purchaser identification, and other information that allows the backend management server 470 to determine if and which backend coupled information handling system 400 listed within the backend management server database is owned by the purchaser/user of the wireless PD as described herein.

At block 410, the wireless PD manufacturer 428 may package the peripheral device 452 and ship the peripheral device 452 off to the user 430. It is appreciated that, in some embodiments, the peripheral device 452 is shipped to the user 430 at an address provided by the user during a purchase request. The purchase request may be completed by a user via an internet e-commerce store, for example, which requests the user's address for shipment to the user 430. It is appreciated, however, that other types of methods of ordering the peripheral device 452 by the user 430 may be used by the user 430 and the present specification contemplates these methods. Further, in an embodiment, the user 430 may be a single user purchasing a peripheral device 452 to be paired with the user's backend coupled information handling system 400. In another embodiment, an ITDM may function as a purchasing agent for one or more user's 430 of a plurality of backend coupled information handling systems 400 as described herein. For ease of understanding, the user 430 in FIG. 4 is a single user. However, the present specification contemplates that the ITDM may also function as a purchasing agent to purchase the peripheral device 452 or multiple peripheral devices 452 on behalf of an enterprise or corporation as described herein.

Turning to block 412, the backend management server 470 receives the temporary key and PD ID from the wireless PD manufacturer 428. Along with the PD ID and temporary key, other temporary key and device identification data may be provided by the wireless PD manufacturer 428 to the automatic PD pairing management system 458. As described herein, this additional data my include data describing the purchaser/user may include a street address, purchase date, a purchaser identification, and other information that allows the backend management server 470 to determine if and which information handling system listed within the backend management server database is owned by the purchaser/user of the wireless PD as described herein.

The method 401 further includes, at block 414, executing code instructions of the automatic peripheral device pairing management system 458 to correlate the purchase of the peripheral device 452 with the user and the temporary key and device identification data (e.g., PD ID and temporary key associated with the purchased peripheral device 452). This data may then be stored in a temporary key/PD ID database at block 416 for later retrieval by the backend management server 470 with execution of the automatic peripheral device pairing management system 458. In an embodiment, at block 418, the backend management server 470 may cross-reference the purchasing data identifying the purchaser with user data maintained by the backend management server database 416 on the backend management server 470. This correlation allows the backend management server 470 to determine whether the purchaser of the peripheral device 452 is a user of a backend coupled information handling system 400. Where the purchaser is not a user of a backend coupled information handling system 400, as determined at the backend management server database 416, the backend management server 470 may ignore the PD ID and temporary key received from the PD manufacturer 428.

Where an identifying match between the purchaser and the user is determined at block 418 by the execution of code instructions of the automatic peripheral device pairing management system 458, the backend management server 470 may be assigned to transmit, securely, the PD ID and temporary key to the automatic peripheral device pairing management system pairing agent 456 at the user's backend coupled information handling system 400 or a backend coupled information handling system 400 assigned to the user. As described herein, at block 420, the backend management server 470 deploys the temporary key and PD ID to the automatic peripheral device pairing management system pairing agent 456 at the backend coupled information handling system 400 with, in an embodiment, a service tag. This service tag may be deployed during execution of (e.g., via a hardware processor of the backend management server 470) a software agent (e.g., Dell® SupportAssist®) including automatic peripheral device pairing management system pairing agent 456 that detects the online presence of the user's backend coupled information handling system 400 and initiates a data transfer session. The backend coupled information handling system 400 may also execute a software agent (e.g., Dell® SupportAssist®) that interfaces with the backend management server 470 as described herein.

Turning to block 432, the automatic peripheral device pairing management system pairing agent 456 at the backend coupled information handling system 400 retrieves the temporary key and PD ID from the backend management server 470 during this transmission. In an embodiment, execution of code instructions of the automatic peripheral device pairing management system pairing agent 456 may control the pairing of a peripheral device 452 described in embodiments herein including the receipt and storage of the PD ID and temporary key on the backend coupled information handling system 400. In an embodiment, the PD ID and temporary key may be stored, at block 434, in UEFI memory device as UEFI variable data. The UEFI memory device is an example, however any memory device may maintain the PD ID and temporary key securely at block 434 until an OS BT stack accesses this data.

The execution of code instructions of the automatic peripheral device pairing management system pairing agent 456 may instruct the OS BT stack to discover the PD ID and temporary key values on the UEFI and store this data in an OS registry or memory in preparation for the automatic discovery, verification, and initiation of BT pairing of the backend coupled information handling system 400 with the peripheral device 452 at block 436. It is appreciated that a hardware processing resource (e.g., a hardware processor, an embedded controller, a CPU, a GPU, etc.) executes computer readable program code of the automatic peripheral device pairing management system pairing agent 456 to perform these processes associated with the operation of the OS BT stack and the automatic discover, verification, and initiation of BT pairing of the backend coupled information handling system 400 with the peripheral device 452.

The method 401 includes, at block 438, the hardware processing resource executing computer readable program code of the OS BT stack to cause the OS BT stack to discover the peripheral device 452 and query the pairing mode. This discovery of the peripheral device 452 is in response to the user 430 unboxing the wireless PD 452 and powering on the wireless PD manufacturer 428 at block 448. This causes, at block 424, the peripheral device 452 to initiate a broadcasting process where the peripheral device 452 broadcasts the PD ID and RSSI transmission level information in an OOB BT broadcast communication pursuant to a Bluetooth OOB pairing protocol, a legacy BLE OOB pairing, a Bluetooth Low Energy (BLE) OOB pairing protocol, or any other suitable protocol to pair the peripheral device 452 to the backend coupled information handling system 400.

The method 401 further includes determining whether the peripheral device 452 is in an OOB mode seeking to be discovered and paired under a BT protocol. Where the peripheral device 452 is not operating under an OOB mode at block 440, the method returns to block 438. Where the peripheral device 452 is operating under an OOB mode and broadcasting a pairing initiation query, the method continues at block 442 with the automatic peripheral device pairing management system pairing agent 456, via the OS BT stack, querying the RSSI signal data levels and PD ID from the peripheral device 452.

The broadcasting of the PD ID for the pairing wireless PD 452 to with the backend coupled information handling system 400 may be conducted via a Bluetooth radio on an OOB BT broadcast communication of the peripheral device 452 as instructed by a hardware processing resource on the peripheral device 452. In an embodiment, a hardware controller on the peripheral device 452 controls the execution of computer readable program code used to initiate the Bluetooth radio and execute the computer readable program code used to query, verify, initiate, and conduct the pairing process with the backend coupled information handling system as described herein.

At block 444, the OS BT stack may engage in verifying whether the PD ID received from the broadcast by the peripheral device matches the PD ID received from the backend management server 470, stored on the UEFI memory device or other memory device, and accessed by the OS BT stack of the backend coupled information handling system 400. Where the PD ID from the broadcast of the peripheral device 452 does not match the PD ID accessed by the OS BT stack, the pairing request from the peripheral device 352 is ignored, prevented, or otherwise disregarded and the method 401 returns to block 438 in one embodiment. In this embodiment, the PD ID from the broadcast of the peripheral device 452 not matching the PD ID accessed by the OS BT stack may indicate that that particular peripheral device 452 has not been assigned to that particular backend coupled information handling system 400. In this particular example embodiment, the ITDM may have accessed the backend management server 470 via the software agent (e.g., Dell® SupportAssist®) and assigned specific peripheral devices 452 to specific backend coupled information handling systems 400 within an enterprise or corporation and the currently broadcasting peripheral device 452 with the unmatched PD ID 468 had not been assigned to the backend coupled information handling system 400. It is also appreciated that multiple sets of temporary keys and PD IDs may have been saved in the UEFI memory device and accessed by the OS BT stack. In this example embodiment, the mismatch of the broadcasted PD ID from the peripheral device 452 may indicate that the peripheral device 452 was assigned to another backend coupled information handling system and not this particular backend coupled information handling system 400 or, potentially, not assigned to any particular backend coupled information handling system 400 within the enterprise or corporation.

Where, at block 444, it is determined that the PD ID broadcasted by the peripheral device 452 matches the PD ID accessed by the OS BT stack, the verification and initiation of the BT pairing process by the automatic peripheral device pairing management system pairing agent 456 may continue with the OS BT stack also checking RSSI transmission level data from the peripheral device. Again, this RSSI transmission level data may determine whether the peripheral device 452 is close enough to be paired with the backend coupled information handling system 400. Again, the peripheral device 452 is configured to also broadcast the RSSI data that is received indicating the signal power level being received by the receiving radio at the backend coupled information handling system 400 from the wireless PD 452. In those examples where an ITDM has ordered a plurality of peripheral devices 452 to be wirelessly paired with any of a plurality of backend coupled information handling systems 400 within the enterprise or corporation, the RSSI data levels provided from the peripheral device 452 may prevent simultaneous pairing of multiple peripheral devices 452 with the backend coupled information handling system 400 based on wireless range and meeting RSSI threshold levels at the backend coupled information handling system 400.

At block 444, the OS BT stack, under direction of a hardware processing device, may compares the RSSI levels received from the peripheral device to the RSSI threshold data received from the UEFI memory device by the OS BT stack. Where the RSSI level received from the peripheral device 452 meets or exceeds the RSSI threshold data, the automatic verification and initiation of the BT pairing process by the automatic peripheral device pairing management system pairing agent 456 continues with the OS BT stack of the backend coupled information handling system 400 and the peripheral device 452 comparing decrypted reciprocally-exchanged temporary keys at block 446. The temporary keys are used to establish the OOB communication channel used to securely pair the peripheral device 452 to the backend coupled information handling system 400. Again, in an embodiment, the BT pairing process may use a Bluetooth OOB pairing protocol, a legacy BLE OOB pairing protocol, a BLE OOB pairing protocol, or any other suitable protocol to establish this session key and pair the peripheral device 452 to the backend coupled information handling system 400 in a BT wireless link.

In one embodiment, the backend coupled information handling system 400 and peripheral device 452 can each provide various pairing verification communications that includes querying the temporary keys and generating a pairing response command between the backend coupled information handling system 400 and wireless PD 452. In an embodiment, the backend coupled information handling system 400 and peripheral device 452 may calculate an Mconfirm value from the temporary key, provide the Mconfirm value to the other device, and receive a calculated Sconfirm from the other device. Where the values match (e.g., Mconfirm=Sconfirm), the BT pairing process proceeds to establish a BT session key pursuant to the BT standard for establishing the BT wireless link. The BT pairing is completed between the peripheral device 452 and backend coupled information handling system 400 at block 450 with the establishment of a session key between the information handling system and the peripheral device. In an embodiment, once the peripheral device 452 is paired with the backend coupled information handling system 400, the temporary key is no longer used and may be discarded or deleted. The single use of the temporary key in an embodiment may increase the security of the BT pairing process allowing for the creation of a session key once the temporary key has initially been used. Once paired, later session may be initiated if and when the information handling system and/or peripheral device 452 have been powered down and powered up. Thus, in an embodiment, the pairing of the backend coupled information handling system 400 with the peripheral device 452 includes the backend coupled information handling system 400 and peripheral device 452 using an OOB protocol to query, verify, and initiate, BT pairing to then establish session keys thereby securely communicating and pairing with each other. At this point the method 401 ends with the backend coupled information handling system 400 and peripheral device 452 being paired until one or both are powered down.

The blocks of the flow diagrams of FIGS. 3 and 4 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating as a backend management server comprising:
a hardware processor;
a memory device;
a power management unit (PMU) to provide power to the processor and memory device;
the hardware processor to execute computer readable program code of an automatic peripheral device pairing management system pairing agent to receive device identification data including peripheral device identifications (PD IDs) associated with a plurality of peripheral devices from a manufacturer of a peripheral device;
the hardware processor establishing temporary key and device identification data to be associated with each of a plurality of peripheral devices based on a pairing assignment of each of the plurality of peripheral devices with one of a plurality of backend coupled information handling systems within an enterprise, where the temporary key and device identification data includes a PD ID and a corresponding temporary key for the peripheral device;
a network interface device sending instructions with a wireless adapter to each of the plurality of backend coupled information handling systems to store temporary key and device identification data associated with the peripheral device assigned to each of the plurality of backend coupled information handling systems, the temporary key and device identification data stored as a unified extensible firmware interface (UEFI) variable in a UEFI memory device accessible at the backend coupled information handling system; and
the network interface device sending instructions to each of the plurality of backend coupled information handling systems to pair the peripheral devices assigned with each of the plurality of backend coupled information handling systems using the temporary key and device identification data assigned to the backend coupled information handling system.

2. The information handling system of claim 1 wherein the instructions sent to each of the plurality of backend coupled information handling systems includes data describing peripheral device verification requirements that require the temporary key and device identification data match peripheral device temporary key and device identification data stored on and provided by the peripheral device.

3. The information handling system of claim 1 further comprising:
the hardware processor generates the temporary key for pairing to the assigned peripheral device to the backend coupled information handling system via a hash function with a serial number of the associated peripheral device used as seed data into the hash function, where the serial number is part of the device identification data.

4. The information handling system of claim 1 further comprising:
the temporary key and device identification data associated with each of the peripheral devices in a plurality of peripheral devices is assigned to a group of the backend coupled information handling systems and includes the temporary key and device identification data of each of the plurality of peripheral devices available to each of the backend coupled information handling systems in the group of backend coupled information handling systems to pair with any of the plurality of peripheral devices when any of the plurality of peripheral devices provides received signal strength indicator (RSSI) above a RSSI threshold level.

5. The information handling system of claim 1 wherein sending the temporary key and device identification data associated with a plurality of peripheral devices by the backend management server includes transmitting the temporary key and device identification data via an encrypted communication channel.

6. The information handling system of claim 1 wherein the device identification data including PD IDs associated with each of the plurality of peripheral devices is received from the manufacturer of the peripheral device via a secure transport layer security encrypted channel.

7. The information handling system of claim 1 wherein sending instructions to each of the plurality of backend coupled information handling systems to store temporary key and device identification data associated with the peripheral device assigned to each of the backend coupled information handling systems includes sending the temporary key and device identification data via a secure transport layer security encrypted channel between the backend management server and the backend coupled information handling systems.

8. A backend coupled information handling system comprising:
a hardware processor;
a memory device;
a power management unit (PMU) to provide power to the processor and memory device;
the hardware processor to execute computer readable program code of an automatic peripheral device pairing management system pairing agent to receive temporary key and device identification data associated with a peripheral device from a backend management server, the backend management server establishing the temporary key and device identification data to be associated with the peripheral device for the assignment to the backend coupled information handling system;
a memory device accessible by the hardware processor storing the temporary key and device identification data associated with the peripheral device assigned to the backend coupled information handling system; and
a wireless adapter establishing an out-of-band (OOB) Bluetooth (BT) communication with the peripheral device to respond to a pairing query from the peripheral device to the backend coupled information handling system when a peripheral device identification (PD ID) is matched with the stored device identification data; and
the hardware processor to determine when the temporary key matches with a peripheral device temporary key stored at the peripheral device assigned to the backend coupled information handling system to initiate a BT wireless link between the backend coupled information handling system and the assigned peripheral device.

9. The backend coupled information handling system claim 8 further comprising:
the wireless adapter establishing the OOB BT communication with the peripheral device includes receiving a peripheral device identification (PD ID) provided by the peripheral device that matches a PD ID provided with the stored device identification data at the backend coupled information handling system from the backend server.

10. The backend coupled information handling system of claim 8 further comprising:
the temporary key and device identification data includes the temporary key created at the backend server via a hash function with a serial number of the peripheral device used as seed data into a hash function to generate the temporary key, where the temporary key stored in a memory in the peripheral device.

11. The backend coupled information handling system of claim 10 further comprising:
the temporary key and device identification data associated with the peripheral device includes a signal strength indicator (RSSI) threshold that, when a measured RSSI is determined to be above the RSSI threshold level from the peripheral device, the peripheral device is then operatively coupled to the information handling system via the OOB BT communication.

12. The backend coupled information handling system of claim 8 wherein establishing the OOB BT communication with the peripheral device includes using an extended BT broadcast wireless communication channel to detect, from the peripheral device, a broadcasted pairing query and peripheral device identification (PD ID) received from the peripheral device.

13. The backend coupled information handling system of claim 8 wherein receiving the temporary key and device identification data associated with the peripheral device from the backend management server includes receiving the temporary key and device identification data via an encrypted communication channel.

14. The backend coupled information handling system of claim 8 further comprising:
the wireless adapter includes an operating system Bluetooth stack, wherein execution of code instructions of the Bluetooth stack queries a unified extensible firmware interface (UEFI) variable from a UEFI memory device, where the temporary key and device identification data are stored as the UEFI variable, to obtain the temporary key and device identification data associated with the peripheral device assigned to the backend coupled information handling system for verification of the peripheral device for BT pairing.

15. The backend coupled information handling system of claim 8 further comprising:
the wireless adapter detecting an unsecured broadcast message from the peripheral device including the pairing query and the PD ID to compare to a peripheral device identification (PD ID) that is a portion of the temporary key and device identification data stored in the memory;
when PD ID matches, initiating a comparison of the temporary key received from the backend server with a peripheral device temporary key stored on memory on the peripheral device to verify BT pairing with the peripheral device; and
the wireless adapter pairing with the detected peripheral device by establishing an encrypted BT communication channel using a session key when the temporary key and PD ID match.

16. A backend coupled information handling system comprising:
a hardware processor;
a memory device;
a power management unit (PMU) to provide power to the processor and memory device;
the hardware processor executing computer readable program code of an automatic peripheral device pairing management system pairing agent to receive a peripheral device identification data (PD ID) and temporary key associated with a peripheral device assigned to the backend coupled information handling system from a backend management server via an encrypted communication channel, where the temporary key and device identification data to be associated with the peripheral device where the temporary key includes a copy peripheral derive (PD) temporary key that is stored in a memory on the peripheral device when that peripheral device authorized to Bluetooth® (BT) pair with the backend coupled information handling system;
a memory device accessible by the hardware processor storing the PD ID and the temporary key associated with the peripheral device assigned to the backend coupled information handling system; and
a wireless adapter establishing an out-of-band (OOB) BT communication broadcast channel with the peripheral device to receive a pairing query and to pair the peripheral device with the backend coupled information handling system on a BT wireless link via a session key when PD ID received from the peripheral device matches and the temporary key stored in memory and the copy PD temporary key at the peripheral device are determined to match by the backend coupled information handling system.

17. The backend coupled information handling system of claim 16 further comprising:
the processor executing code instructions of an operating system Bluetooth stack querying a unified extensible firmware interface (UEFI) variable at the memory that is a UEFI memory to obtain the PD ID and temporary key for the peripheral device prior to pairing with the peripheral device.

18. The backend coupled information handling system of claim 16 wherein the temporary key and copy PD temporary key are created via a hash function of a serial number of the peripheral device used as seed data.

19. The backend coupled information handling system of claim 16 further comprising:
the hardware processor to calculate an Mconfirm value from the stored copy of the temporary key via a cipher algorithm and provide Mconfirm to the wireless PD;
the wireless adapter to receive a calculated Sconfirm from the wireless peripheral device that calculated a PD Sconfirm value from its own stored copy of the PD temporary key; and
the hardware processor to verify BT pairing with a match of the received Sconfirm from the wireless peripheral device with the calculated Mconfirm at the information handling system.

20. The backend coupled information handling system of claim 16 further comprising:
the wireless adapter detecting an unsecured broadcast message from the peripheral device and obtaining PD ID from the peripheral device in the OOB BT communication channel that is used by the wireless adapter to compare it to the PD ID stored at the backend coupled information handling system before initiating BT pairing with the peripheral device.
